(19) United States
(12) Patent Application Publication
(10) Pub. No.: US 2026/0052059 A1
(43) Pub. Date: Feb. 19, 2026

(54) Detecting and Recovering From Network Failures

(71) Applicant: Clockwork Systems, Inc., Palo Alto, CA (US)

(72) Inventors: Rahul Bothra, Urbana, IL (US); Katherine Gioioso, Mountain View, CA (US); Vinay Kotikalapudi Sriram, Palo Alto, CA (US); Akram O. Sbaih, Mountain View, CA (US); Yilong Geng, Menlo Park, CA (US)

(21) Appl. No.: 19/300,541

(22) Filed: Aug. 14, 2025

Related U.S. Application Data
(60) Provisional application No. 63/683,490, filed on Aug. 15, 2024.
(60) Provisional application No. 63/692,454, filed on Sep. 9, 2024.

(51) Int. Cl. H04L 41/0663; H04L 41/0604; H04L 41/0631

(52) U.S. Cl. CPC H04L 41/0663; H04L 41/0627; H04L 41/0645

(57) ABSTRACT

A method or system for mitigating payload failures in a networked computing environment. A payload failure is detected at either a sender or receiver NIC based on one or more health metrics, such as timeouts, transmission errors, or latency anomalies. In response, the system spoofs progress to the upstream application by signaling that data transmission is continuing, thereby preventing disruption or termination of the application process. A backup NIC is selected from the available NICs at the sender or receiver host based on one or more efficiency metrics, including a proximity metric (e.g., NUMA locality) and a utilization metric (e.g., current traffic load). Data transmission is then rerouted to the selected backup NIC, maintaining operational continuity.

### CROSS REFERENCE TO RELATED APPLICATIONS

This application claims the benefit of U.S. Provisional Patent Application No. 63/683,490, filed on Aug. 15, 2024, and U.S. Provisional Patent Application No. 63/692,454, filed on Sep. 9, 2024, all of which are hereby incorporated by reference in their entirety.

### TECHNICAL FIELD

This disclosure relates generally to network transmissions and coordinated control of network traffic within data flows, and more specifically to detecting and recovering from payload failures along network paths.

### BACKGROUND

Network technologies that provide high throughput and low latency have been emerging to facilitate workloads demanded by cutting-edge platforms, such as AI tools like LLMs. Such network technologies include (but are not limited to) RoCE (Remote Direct Memory Access over Converged Ethernet) and InfiniBand.

RoCE allows RDMA over an ethernet network. RDMA enables direct memory access from the memory of one computer into that of another without involving either one's operating system. This direct memory access capability reduces latency, decreases CPU load, and improves performance. InfiniBand is another type of high-performance, low-latency networking technology used primarily in supercomputing setups.

Common failures in such high throughput and low latency networks include packet loss, congestion, and/or software or hardware issues. Network Interface Cards (NICs) can also be a source of failures in these networks. For example, NICs can suffer performance degradation due to overheating. Bus or glitches in firmware on NICs can also lead to improper functioning of network operations.

In existing high-throughput low-latency networks, when a NIC fails, collective libraries either send errors to the upstream application or continuously send data that will eventually fail. The effects of such failures can be significant due to the critical nature of the applications relying on these networks. One of the primary benefits of these networks is low latency. Network failures can cause an increase in latency, which degrades the performance of applications, particularly those sensitive to timing, such as real-time data processing or high-frequency trading platforms. Severe or unhandled network failures can lead to system crashes or the freezing of operations, requiring a reboot and resulting in operational downtime.

### SUMMARY

Systems and methods described herein address the limitations of current protocol implementations by monitoring the health of a network to detect failures, and automatically recovering from detected failures.

In some embodiments, a system detects a payload failure at a sender Network Interface Card (NIC) among a plurality of sender NICs or a receiver NICs among a plurality of receiver NICs along a path between a sender host and a receiver host based on one or more health metrics. Responsive to detecting the payload failure, the system spoofs progress to an upstream application by signaling that current data transmission is ongoing, such that the upstream application does not detect the payload failure. An upstream application in the context of networked computing environments refers to a software application that relies on data from lower-level or downstream network components within a network infrastructure. The upstream application operates at a higher level in the data processing hierarchy, relying on the successful operation and data delivery from downstream components to function correctly. For example, an upstream application may be a server that consumes data transmitted by downstream network elements, such as NICs, switches, and routers.

The system selects at least one backup NIC from the plurality of NICs of the sender host or the receiver host based on one or more efficiency metrics. For example, if a sender NIC is the cause of failure, a backup sender NIC is selected from the plurality of sender NICs; if a receiver NIC is the cause of failure, a backup receiver NIC is selected from the plurality of receiver NICs; or if both the sender NIC and the receiver NIC are cause of failure, a backup sender NIC and a backup receiver NIC are selected. The one or more efficiency metrics include a proximity metric and a utilization metric of each of the plurality of NICs. The system fails over data transmission from the previous NIC to the selected at least one backup NIC.

The method and system described herein enable sender and receiver directly coordinate failover management without relying on a centralized control system, enhancing resilience and response speed during failures.

### BRIEF DESCRIPTION OF THE DRAWINGS

FIG. 1 is an exemplary system environment for implementing netcam and priority functions, according to an embodiment of the disclosure.

FIG. 2 is a network traffic diagram showing multiple sender hosts sending multiple data flows to a single receiver host, according to an embodiment of the disclosure.

FIG. 3 is a network traffic diagram showing a timestamping operation at both a sender and receiver side of a data transmission, according to an embodiment of the disclosure.

FIG. 4 is a data flow diagram showing netcam activities during normal operation and where an anomaly is detected, according to an embodiment of the disclosure.

FIG. 5 is a network traffic diagram showing a receiver host receiving both high and low priority traffic from sender hosts, according to an embodiment of the disclosure.

FIG. 6 is a data flow diagram showing netcam activities where priorities are accounted for in determining netcam activity, according to an embodiment of the disclosure.

FIG. 7 is a flowchart that illustrates an exemplary process for performing netcam activities, according to an embodiment of the disclosure.

FIG. 8 is a flowchart that illustrates an exemplary process for performing netcam activities in a multiple priority scenario, according to an embodiment of the disclosure.

FIG. 9 is a data flow diagram showing netcam activities where shadow buffer considerations are depicted, according to an embodiment of the disclosure.

FIG. 10 is a flowchart that illustrates an exemplary process for performing netcam activities in coordination with shadow buffer considerations, according to an embodiment of the disclosure.

FIG. 11 illustrates exemplary sub-modules of a netcam module for use in a long-link environment, in accordance with an embodiment of the disclosure.

FIG. 12 illustrates a graphical depiction of an application for applying quantized pauses, in accordance with an embodiment of the disclosure.

FIG. 13 is a flowchart that illustrates an exemplary process for deploying quantized pauses in connection with netcam activities on long-range links, in accordance with an embodiment of the disclosure.

FIG. 14 is a network diagram for an exemplary multi-stage interconnection network, in accordance with an embodiment.

FIG. 15 shows exemplary shadow queue pairs instructed to follow paths of their corresponding application queue pairs.

FIG. 16 is a flowchart of an example method for mitigating payload failures at a NIC of a sender or receiver host in a network environment, in accordance with an embodiment.

FIG. 17 is a diagram for an example process of failing over in response to detecting payload failure at a NIC of a sender or receiver host in a network environment, in accordance with an embodiment.

FIG. 18 is a flowchart of an example method for mitigating payload failures along a network path in a network environment, in accordance with an embodiment.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

High-performance network environments—such as those used in AI infrastructure, data centers, and low-latency trading systems—are increasingly vulnerable to disruptions caused by hardware failures, congestion, or transient path degradations. Traditional network protocols either escalate failures to upstream applications, causing crashes and service interruptions, or rely on retransmissions over the same failing hardware, which prolongs outages and exacerbates bottlenecks. These limitations are especially problematic in systems with strict latency, availability, and throughput requirements.

The system and method described herein addresses this gap by proactively detecting payload failures and seamlessly failing over to backup NICs while spoofing progress to upstream applications. This results in improved system resilience, minimal downtime, and reduced risk of data loss or application-level crashes, even under high-throughput or fault-prone conditions.

Additionally, the system's ability to perform spatial retransmission-switching to alternate NICs instead of retrying on a failed one-introduces a new layer of fault isolation and recovery speed. This is particularly valuable in distributed cloud environments and hyperscale data centers where centralized control is often infeasible due to scale. By enabling sender and receiver hosts to coordinate failover autonomously, the architecture avoids dependency on global state management, leading to faster recovery and greater horizontal scalability. These features help optimize resource utilization, reduce operational overhead, and maintain predictable network performance in environments where deterministic latency and reliability are paramount.

Systems and methods are disclosed herein for mitigating payload failover in a networked computing environment. A network path may be represented by a tuple including a sender NIC at a sender host, a receiver NIC at a receiver host, and a flow label. A flow label is an identifier used to manage and track specific data flows across network paths. In some embodiments, a flow label may be a part of a data packet header.

A network path is healthy if components (e.g., NICs, switches) along the network path can properly transmit data from the sender host to the receiver host. When the network path cannot properly transmit data, payload failure occurs. A payload failure refers to a disruption in the successful transmission or reception of data across a network path. It occurs when data (the “payload”) sent from a sender host fails to arrive correctly or within expected time bounds at the receiver host. This failure may manifest as dropped packets, excessive latency, timeouts, or incomplete transmissions that affect the overall integrity or timeliness of communication.

A NIC failure is a specific type of payload failure that arises from malfunction or degradation in a Network Interface Card (NIC), which is responsible for transmitting or receiving data on behalf of a host. Common causes include hardware defects, overheating, firmware bugs, or congestion-related stalls at the NIC level. A path failure refers to failures occurring within the network path between sender and receiver NICs, including issues in intermediate components such as switches, routers, or links. This may include congestion, link instability, ECN (Explicit Congestion Notification) saturation, or physical connectivity problems.

Payload failure is an umbrella term that includes both NIC failures and path failures. In other words, any condition-whether at the endpoint (NIC) or within the network fabric-that prevents payload data from being transmitted reliably constitutes a payload failure. The system described herein monitors for these failures holistically and responds by initiating seamless failover and recovery, regardless of whether the root cause lies in the NIC or along the transmission path.

The sender host or the receiver host may include multiple NICs. For example, the sender host may include a primary sender NIC, and one or more backup sender NICs; and the receiver host may include a primary receiver NIC, and one or more backup receiver NICs.

In some embodiments, a system detects a payload failure at a sender NIC or a receiver NIC along a network path between a sender host and a receiver host based on one or more health metrics. In some embodiments, the one or more health metrics include at least a timeout in data transmission, an error in sending or receiving data, or a completion queue status. In some embodiments, the one or more health metrics are obtained from one or more of a probe mesh, shadow queue pair, application level indicators, and/or a centralized scheduler.

In some embodiments, the system uses hardware timestamps collected by shadow queue pairs or a probe mesh to measure one-way delays as a proxy for the quality of network path, providing a quantitative metric for assessing path health that can dynamically influence routing decisions, especially during failover scenarios.

Responsive to detecting payload failure at a NIC, the system spoofs progress to an upstream application by signaling that current data transmission is ongoing, such that the upstream application does not detect the payload failure. The system selects at least one backup NIC from the plurality of NICs based on one or more efficiency metrics. The one or more efficiency metrics include a proximity metric and a utilization metric of each of the plurality of NICs.

Responsive to selecting a backup NIC, the system failovers data transmission from the original NIC to the at least one backup NIC. In some embodiments, failing over data transmission from the first NIC to the at least one backup NIC includes transitioning all queue pairs between the sender host and the receiver host to a RESET state.

In some embodiments, the system tracks complete data transfers by comparing a sender-side complete log and a receiver-side complete log. The system drains all completion queues, and retransmits only incomplete queues that are not in the combined completion log.

In some embodiments, after a failover event, the system continuously monitors the health of the original NIC. If the original NIC recovers, the system can revert data transmission back to it, maintaining efficiency and reducing the overhead associated with using backup NICs longer than necessary.

In some embodiments, the methods and systems described herein can be used to redistribute application workloads to spread traffic across different NICs within the same host. The redistribution of application workloads may be based on factors such as non-uniform memory access (NUMA) distance to minimize peripheral component interconnect express (PCIE) contention and balance traffic based on NIC utilization. As such, the network performance can be improved by ensuring that no single NIC becomes a bottleneck.

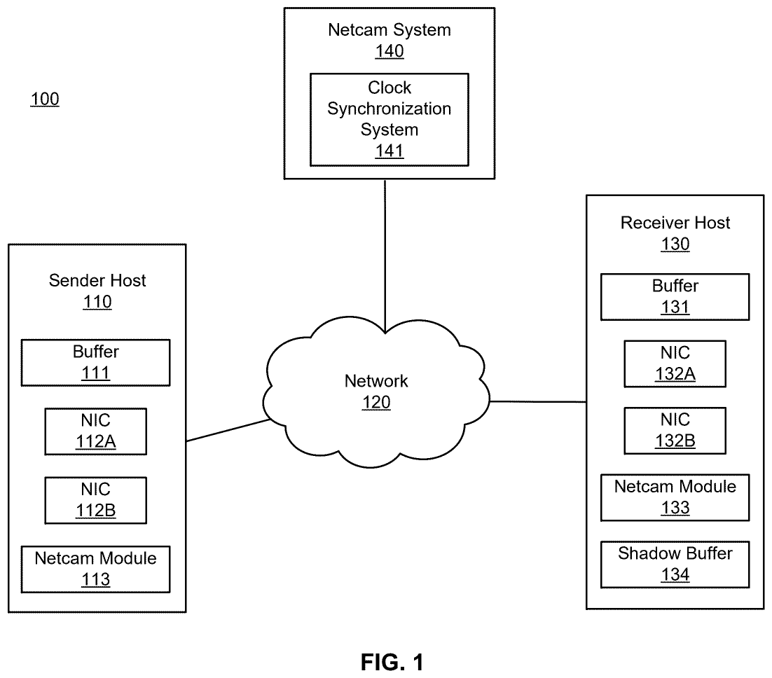

Unlike traditional retransmission methods that resend data through the same NIC (temporal retransmission), the methods and system described herein enable switching to a different NIC (spatial retransmission). This approach is particularly useful when a NIC fails due to issues like overheating, as it allows the faulty NIC to cool down while maintaining network operations through an alternative NIC. Further, the process described herein allows sender and receiver hosts to coordinate directly to manage failovers without relying on a centralized control system. This enhances the speed and responsiveness of the failover process, allowing for quicker recovery from failures and potentially reducing downtime. Additional details about the system are further described below with respect to FIGS. 1-18.

### Example System Environment

FIG. 1 is an exemplary system environment for implementing netcam and priority functions, according to an embodiment of the disclosure. As depicted in FIG. 1, netcam environment 100 includes sender host 110, network 120, receiver host 130, and clock synchronization system 140. While only one of each of sender host 110 and receiver host 130 is depicted, this is merely for convenience and ease of depiction, and any number of sender hosts and receiver hosts may be part of netcam environment 100. In some embodiments, a sender host 110 may also be a receiver host, and vice versa, such that the two hosts are capable of communicating with each other.

Sender host 110 includes buffer 111, one or more Network Interface Cards (NICs) 112A, 112B, and netcam module 113. Buffer 111 stores a copy of outbound data transmissions until one or more criteria for overwriting or discarding packets from the buffer is met. For example, the buffer may store data packets until it is at capacity, at which time the oldest buffered data packet may be discarded or overwritten. Other criteria may include a time lapse (e.g., discard packets after predetermined amount of time has elapsed from its transmission timestamp), an amount of packets buffered (e.g., after a predetermined amount of packets are buffered, begin to discard or overwrite oldest packet as new packets are transmitted), and the like.

In an embodiment, buffer 111 stores information relating to given outbound transmissions, rather than entire packets. For example, a byte stamp may be stored rather than the packet itself, the byte stamp indicating an identifier of the packet and/or flow identifier and a time stamp at which the packet (or aggregate data flow) was sent. In such an embodiment, the stored information need not be overwritten, and may be stored to persistent memory of sender host 110 and/or clock synchronization system 140. This embodiment is not mutually exclusive to buffer 111 storing copies of packets, and they may be employed in combination.

NIC 112A or 112B may be any kind of network interface card, such as a smart NIC. NIC 112A or 112B interfaces sender host 110 and network 120.

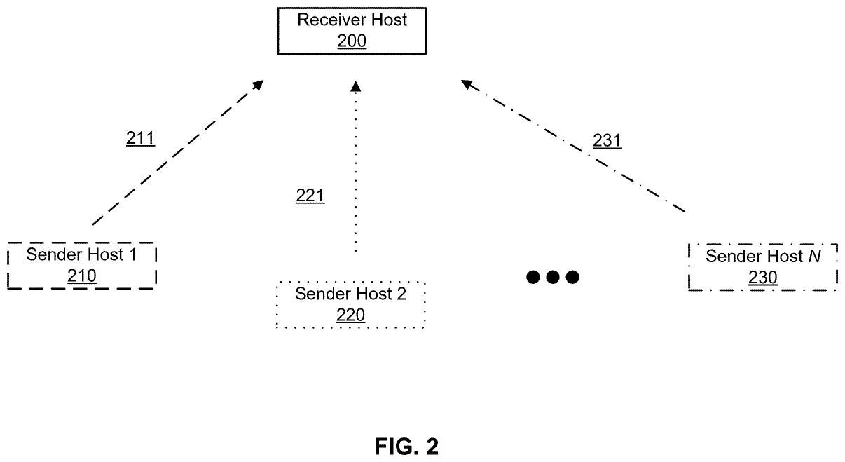

Netcam module 113 monitors data flow for certain conditions, and triggers functionality based on the monitored data. As an example, netcam module 113 may, responsive to detecting network congestion, instruct all hosts that are part of a data flow to perform one or more of various activities, such as pausing transmissions, taking a snapshot of buffered data transmissions (that is, writing buffered data packets to persistent memory), and performing other coordinated activity. As used herein, the term data flow may refer to a collection of data transmissions between two or more hosts that are associated with one another. Further details of netcam module 113 are described with respect to FIGS. 2-8 below. Netcam module 113 may be implemented in any component of sender host 110. In an embodiment, netcam module 113 may be implemented within NIC 112A or 112B. In another embodiment, netcam module 113 may be implemented within a kernel of sender host 110.

Network 120 may be any network, such as a wide area network, a local area network, the Internet, or any other conduit of data transmission between sender host 110 and receiver host 130. In some embodiments, network 120 may be within a data center housing both sender host 110 and receiver host 130. In other embodiments, network 120 may facilitate cross-data center transmissions over any distance. The mention of data centers is merely exemplary, and sender host 110 and receiver host 130 may be implemented in any medium including those that are not data centers.

Receiver host 130 includes netcam buffer 131, one or more NICs 132A, 132B, netcam module 133, and shadow buffer 134. Netcam buffer 131, NIC 132A, 132B, and netcam module 133 operate in similar manners to the analog components described above with respect to sender host 110. Buffer 131 may be a same size or a different size from buffer 111, and may additionally or alternatively store byte stamps for received packets. Any further distinctions between these components as implemented in sender versus receiver host will be apparent based on the disclosure of FIGS. 2-8 below.

Shadow buffer 134 may be used for tracking data traffic in a manner that enables an early warning of when congestion is likely to come. For example, as data traffic is buffered, congestion may occur when the buffer is full, the congestion preventing further data traffic from flowing until the congestion is cleared. A shadow buffer may increment a counter more quickly than regular buffer (e.g., increment by 1.1 where 1 unit of data is received at a regular buffer), and/or may decrement the counter more slowly than a regular buffer (e.g., decrement by 0.9 or 0.95 where 1 unit of data is cleared at the regular buffer). The term regular buffer, as used herein, may refer to activity of buffers 111 and/or buffer 131 and/or other buffers disclosed herein having similar functionality to that of buffers 111 and/or 131. While only one shadow buffer 134 is depicted in FIG. 1, multiple shadow buffers may be employed at receiver hosts, and each shadow buffer may be allocated to a different subset of data flows, such as data flows each corresponding to a same application. The shadow buffers may increment/decrement at different rates (e.g., to show more congestion for lower priority applications, and to show less congestion for higher priority applications). Alternatively, the shadow buffers may increment/decrement at same rates, but different thresholding may be applied for different applications as to when a data flow should be considered to be facing congestion. Data buffered in a regular buffer includes data traffic (e.g., network packets) received by a receiver; the data is removed from the regular buffer as the data is processed and/or routed to a next destination. Activity described herein of netcam module 113 and/or netcam system 140 taking action with respect to conditions being met with respect to regular buffers may equally be performed where shadow buffer 134 indicates congestion.

Netcam system 140 includes clock synchronization system 141. Netcam system 140 may monitor data observed by the netcam modules implemented in hosts, such as netcam module 131 and 133. Netcam system 140 may detect conditions that require action by the netcam modules and may transmit instructions to affected netcam modules to take coordinated action for a given data flow. Clock synchronization system 141 synchronizes one or more components of each host, such as the NIC, the kernel, or any other component within which the netcam modules act. Details of clock-synchronization are described in commonly-owned U.S. Pat. No. 10,623,173, issued Apr. 14, 2020, the disclosure of which is hereby incorporated by reference herein in its entirety. Each host is synchronized to an extremely precise degree to a same reference clock, enabling precise timestamping across hosts regardless of host location, bandwidth conditions of the host, jitter, and the like. Further details of netcam system 140 are disclosed below with reference to FIGS. 2-8. Netcam system 140 is an optional component of netcam environment 100, and the netcam modules of the sender and/or receiver hosts can operate netcam modules without reliance on a centralized system, other than reliance on a reference clock with which to synchronize.

There are many advantages of netcam environment 100. The netcam modules are edge-based, given that they can run in the kernel or in NICs (e.g., smart NICs) of a host (e.g., physical host, virtual machine, or any other form of host). In an embodiment, the netcam functionality may run as an underlay, meaning that it may run, e.g., as a shim, on a layer of the OSI system under a congestion control layer (e.g., layer 3 of the OSI system). The netcam modules and/or netcam system 140 may instruct hosts to perform activity upon detection of a condition (e.g., a congestion signal is detected using a shadow buffer), such as pausing transmission of a data flow across affected hosts, taking a snapshot (that is, writing some or all of the buffered data, such as the last N bytes transmitted and/or the bytes transmitted in the last S seconds, where N or S may be default values or defined by an administrator), and any other activity disclosed herein. Further advantages and functionality are described below with respect to FIGS. 2-8.

FIG. 2 is a network traffic diagram showing multiple sender hosts sending multiple data flows to a single receiver host, according to an embodiment of the disclosure. As depicted in FIG. 2, sender host 1 is sending data flow 211 to receiver host 200, sender host 220 is sending data flow 221 to receiver host 200, and, represented by sender host 230, any number of additional hosts may be transmitting respective data flows (represented by data flow 231) to receiver host 200. As depicted in FIG. 2, each data flow sent by each sender host is different; however, this is merely for convenience two or more sender hosts may transmit data from the same data flow. Moreover, a single sender host may send two or more different data flows to receiver host 200. While only one receiver host is depicted, sender hosts may transmit data flows to any number of receiver hosts.

### Network Traffic Monitoring and Congestion Detection

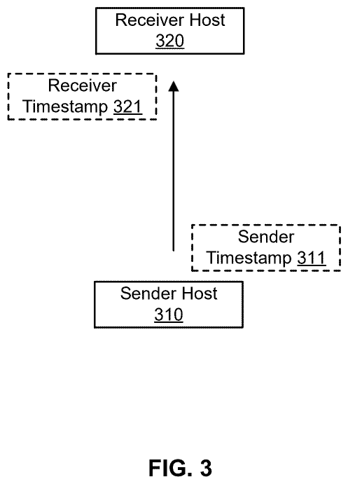

We turn to the moment now to FIG. 3 to discuss operation of netcam modules at sender and receiver hosts. FIG. 3 is a network traffic diagram showing a timestamping operation at both a sender and receiver side of a data transmission, according to an embodiment of the disclosure. As depicted in FIG. 3, when sender host 310 transmits a packet to receiver host 320, netcam module 113 of receiver host 320 records sender timestamp 311. Similarly, when receiver host 320 receives the packet, netcam module 133 of receiver host 320 applies receiver timestamp 321. The timestamp reflects a time at which the data packet was sent or received by the relevant component on which the netcam module is installed (e.g., NIC, kernel, etc.). Sender timestamps may be stored in buffers 111 and 131, appended to packets, transmitted for storage in netcam system 140, or any combination thereof.

Because sender host 310 is synchronized to a same reference clock as receiver host 320, the elapsed time between the time of sender timestamp 311 and receiver timestamp 321 reflects a one-way delay for a given packet. In an embodiment, in response to receiving a given packet, receiver host 320 transmits an acknowledgment packet to sender host 310 that indicates receiver timestamp 321, by which netcam module 113 can calculate the one-way delay by subtracting the sender timestamp 311 from the receiver timestamp 321. Other means of calculating the one-way delay are within the scope of this disclosure. For example, the sender timestamp 311 may be appended to the data transmission, and receiver host 320 may thereby calculate the one-way delay without a need for an acknowledgment packet. As yet another example, the netcam modules of sender hosts and receiver hosts may transmit, either in batches or individually, timestamps to netcam system 140, which may calculate one-way delay therefrom. For the sake of convenience and brevity, the scenario where sender host 110 calculates one-way delay based on an acknowledgment packet will be the focus of the following disclosure, though one of ordinary skill in the art would recognize that any of these means of calculation equally apply.

In an embodiment, the netcam system then determines whether the one-way delay exceeds a threshold. For example, after calculating one-way delay, sender host 110 may compare the one-way delay to the threshold. The threshold may be predetermined or dynamically determined. Predetermined thresholds may be set by default or may be set by an administrator. As will be described further below, different thresholds may apply to different data flows depending on one or more attributes of the data flows, such as their priority. The threshold may be dynamically determined depending any number of factors, such as dynamically increasing the threshold as congestion lowers, and decreasing the threshold as congestion rises (e.g., because delay is more likely to be indicative of a problem where congestion is not a cause or is a minor cause). In one embodiment, thresholds may be set on a per-host basis, as they may depend on a distance between a sender host and a receiver host. In such an embodiment, the threshold may be a predefined multiple of a minimum one way delay between a sender and a receiver host. That is, the minimum amount of time by which a packet would need to travel from a sender host to a receiver host would be a minimum one-way delay. The multiple is typically 1.5×-3× the minimum, but may be any multiplier defined by an administrator of the netcam. The threshold is equal to the multiple times the minimum one-way delay. Responsive to determining that the one-way delay exceeds the threshold, netcam module 113 may instruct sender host 110 to take one or more actions.

In some embodiments, determining whether to take one or more actions may be performed using a separate measure of a status of a shadow buffer (e.g., shadow buffer 134). In short (further detail will be described below), during a given data flow, and in parallel with buffering data using a regular buffer, netcam module 133 may instruct shadow buffer 134 be incremented for each unit of data traffic received by receiver host 320. Netcam module 133 may define a dynamic drain rate, which is a rate at which netcam module 133 instructs shadow buffer 134 be decremented. The dynamic drain rate may be determined by netcam module 133 based on a number of units of data removed from buffer 131 per unit of time (e.g., multiplied by a factor that causes drain to occur more slowly in shadow buffer 134 than it occurs in buffer 131). Netcam module 133 may calculate a dwell time as a function of the counter of shadow buffer 134 and the dynamic drain rate (e.g., the dwell time may be calculated by a value of the counter of the shadow buffer divided by the dynamic drain rate). From here, netcam module 133 may determine a one-way delay of the shadow buffer to be the actual one-way delay (determined from the sender and receiver timestamps, described above) as aggregated with the dwell time. The one-way delay of the shadow buffer may be used for comparison against the threshold (in addition to, or instead of, the one-way delay of the regular buffer) to determine whether to take one or more actions.

Whether driven by the regular buffer or the shadow buffer one-way delay, these one or more actions may include pausing transmission from that sender host when one-way delay is high, which reduces congestion and thereby reduces packet drops on network 120 in general. The pause may be for a predetermined amount of time, or may be dynamically determined proportionally to the magnitude of the one-way delay. In an embodiment, the pause may be equal to the one-way delay or may be determined by applying an administrator-defined multiplier to the one-way delay. In an embodiment, the netcam determines whether a prior pause is being enforced, and if so, may reduce the pause time based on a prior amount of pause time that has already elapsed from previously acknowledged packets. Moreover, a given data flow may not be the only data flow contributing to congestion, and thus its pause duration may be smaller than the one-way delay or the one-way delay threshold.

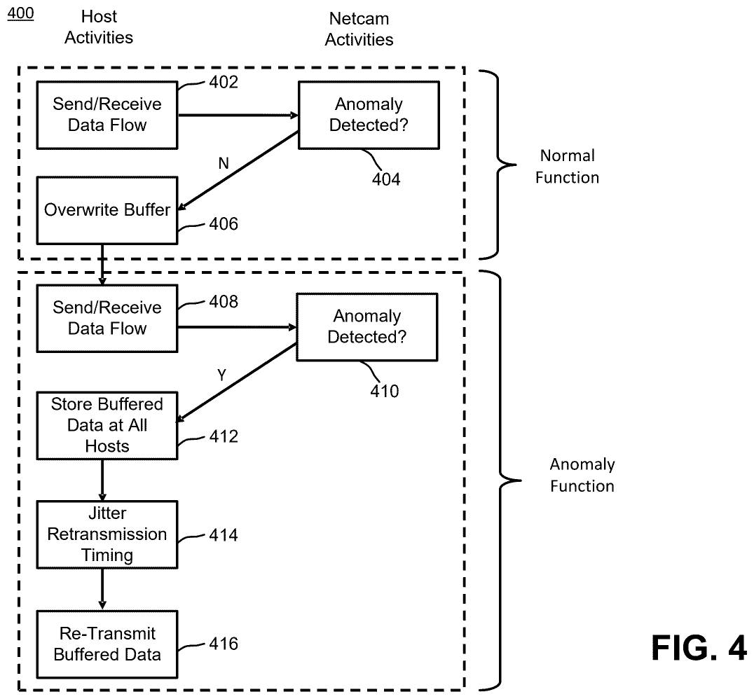

Another action that may be taken is to write some or all buffered data packets (e.g., from either or both of the sender host and receiver host) to persistent memory responsive to the one-way delay exceeding the threshold. Diagnosis may then be performed on the buffered data packets (e.g., to identify network problems). Further actions are described with respect to FIGS. 4-8 in further detail below.

In some embodiments, data flows may be associated with different priorities. Netcam modules may determine priority of data flows either based on an explicit identifier (e.g., an identifier of a tier of traffic within a data packet header), or based on inference (e.g., based on heuristics where rules are applied to packet header and/or payload to determine priority type). Priority, as used herein, refers to a precedence scheme for which types of data packets should be allowed to be transmitted, and which should be paused, during times of congestion. The priorities disclosed herein avoid a need for underutilizing a link or making explicit allocations of bandwidth, and instead are considered in the context of choosing what packets to transmit during network congestion.

In order to prioritize high priority packets, a high one-way threshold may be assigned to high priority traffic, and a low, relative to the high one-way threshold, may be assigned to the low priority traffic. These thresholds may be used for comparison against either, or both of, a shadow buffer one-way delay and/or a regular buffer one-way delay. In this manner, low priority packets will have anomalies detected more frequently than high priority packets, because a lower one-way delay is required to be detected for a low priority packet for an anomaly to be detected by a netcam module, whereas high priority packets will have anomalies detected only when a higher one-way delay threshold has been breached. Following from the above discussion of determining the one-way threshold for a given host, different one-way thresholds may be applied to different data packets that are sent by or received by a same host depending on priority. In priority embodiments, the one-way threshold may be determined in the manner described above (e.g., by applying a predetermined multiplier to the threshold), where the determination is additionally influenced by applying a priority multiplier. The priority multiplier may be set by an administrator for any given type of priority, but will be higher for higher priorities, and lower for lower priorities. Priority need not be binary-any number of priority tiers may be established, each corresponding to a different type or types of data traffic, and each having a different multiplier. Priorities and their associated multipliers may change over time for given data flows (e.g., where a data flow begins transmitting a different type of data packet that does not require high latency transmission, priority may be reduced).

Additionally or alternatively to using a priority multiplier on one-way delay thresholds and differentiating one-way delay thresholds based on priority of a given packet or data flow within which a packet is transmitted, the netcam modules may manipulate the pause time of paused traffic during a pause operation differently depending on priority. A low pause time may be assigned to higher priority traffic, and a relatively high pause time may be assigned to lower priority traffic, ensuring that lower priority traffic is paused more often than high priority traffic during times of congestion, and thereby ensuring that higher priority traffic has more bandwidth available while the lower priority traffic is paused. The pause times may be determined in the same manner as described above, but with the additional step of applying an additional pause multiplier to the pause times, with lower pause multipliers (e.g., multipliers that are less than 1, such as 0.7×) for high priority traffic, and higher pause multipliers (e.g., multipliers that are more than 1) for lower priority traffic.

Priority may be allocated in any number of ways. In an embodiment, one or more “carpool lanes” may be allocated that can be used by data flows having qualifying priorities. For example, a “carpool lane” may be a bandwidth allocation that does not guarantee a minimum bandwidth for a given data communication, but that can only be accessed by data flows satisfying requisite parameters. Exemplary parameters may include one or more priorities that qualify to use the reserved bandwidth of a given “carpool lane.” As an example, a carpool lane may require that a data flow has at least a medium priority, and thus both medium and high priorities qualify in a 3-priority system having low, medium, and high priorities. As another example, multiple carpool lanes may exist (e.g., a carpool lane that can only be accessed by high priority traffic in addition to a carpool lane that can be accessed by both medium and high priority traffic).

In an embodiment, guaranteed bandwidth may be allocated to a given priority. For example, a high priority data flow may be allocated a minimum bandwidth, such as 70 mbps. In such an embodiment, excess unused bandwidth from what is guaranteed may be allocated to lower priority data flows until such a time that the bandwidth is demanded by a data flow that qualifies for the guarantee. Guaranteed bandwidth may be absolute or relative. Relative guarantees ensure that a given priority data flow will receive at least a certain relative amount more bandwidth than a low priority data flow. For example, a high priority data flow may be guaranteed 3× the bandwidth of a low priority data flow, and a medium priority data flow may be guaranteed 2× the bandwidth of a low priority data flow.

Returning to FIG. 2, where two or more sender hosts transmit data from a same data flow, those nodes, in tandem, and in addition to any receiver hosts that are receiving the data from the data flow, may be referred to as a “cluster.” In an embodiment, a data flow may be identified by a collection of identifiers that, if all detected, represent that a data packet is part of a data flow. For example, a netcam module of any host may determine a flow identifier that identifies a data flow to which a packet belongs based on a combination of source address, destination address, source port number, destination port number, and protocol port number. Other combinations of identifiers may be used to identify a data flow to which a packet is a part. As stated before, the hosts of the cluster are all clock-synchronized against a same reference clock, no matter their form (e.g., server, virtual machine, smart NIC, etc.).

In a scenario where data flows 211 and 221 are a same data flow, sender host 210, sender host 220, and receiver host 200 form a cluster. Following this example, buffering of data packets (across both regular buffers and shadow buffers) may occur on a per-flow level across a cluster of hosts. That is, one or more netcam modules and/or netcam system 140 may record within buffers of hosts of a data flow all packets transmitted or received within whatever parameter the buffer uses to record and then overwrite data (e.g., most recently transmitted packets, packets transmitted/received within a given amount of time, etc.). Moreover, a receiver node receiving packets of a data flow from multiple sender hosts (e.g., receiver host 200 receiving packets from sender hosts 210 and 220) may maintain a single shadow buffer for the data flow, or may maintain separate shadow buffers, one for each of sender host 210 and sender host 220. In an embodiment, indicia of a timed sequence, relative to the reference clock, is stored with the buffered data (e.g., sender timestamp 311 and/or receiver timestamp 321 is stored with a buffered data packet). Thus, sender host 210 and sender host 220 may store in their buffers 111 data packets that share a given flow ID, and receiver host 200 may store received packets within buffer 131. Alternatively or additionally, transmitted and/or received packets may be transmitted to netcam system 140, which may buffer received data.

From this vantage point of buffering a certain amount of data at each host of a cluster, different functionality of host netcam modules is possible responsive to detection of an anomaly (e.g., the aforementioned conditions mentioned with respect to FIG. 2 above). FIG. 4 is a data flow diagram showing netcam activities during normal operation and where an anomaly is detected, according to an embodiment of the disclosure. Data flow 400 reflects host activities and netcam activities (e.g., activities taken by netcam modules of sender/receiver hosts or netcam system 140) during normal function, and during an “anomaly function” (that is, action taken where an anomaly is detected). Data flow 400 first shows normal function, where hosts send or receive 402 data flows, and the netcam module or system (referred to generally in this figure as “netcam”) determines 404 whether an anomaly is detected (e.g., based on one-way delay, as discussed above). Where no anomaly is detected, on the assumption that the buffer is full from prior storage of data packets, the host(s) (e.g., of a cluster) overwrite 406 their buffer(s) (e.g., meaning overwrite oldest packet or follow some other overwrite heuristic as described above). Of course, where buffers are not full, overwriting is not necessary, and storing to a free memory of the buffer occurs. Normal function repeats unless an anomaly is detected.

Anomaly function occurs where an anomaly is detected. Different anomaly functions are disclosed herein, and data flow 400 focuses on illustrating a particular anomaly function of re-transmitting buffered data. Where sending/receiving 408 information of a data flow by hosts (e.g., of a cluster), the netcam may detect 410 an anomaly. As mentioned above, anomalies are detected where one-way delay (e.g., of a shadow buffer and/or of a regular buffer) exceeds a threshold. Recall that for a cluster, the threshold may vary between hosts of the cluster depending on distance between sender and receiver hosts. Responsive to detecting the anomaly, the netcam instructs 412 the buffered data to be stored at all hosts of the cluster. That is, where an anomaly occurs on even one host of a cluster, data from all nodes of the cluster is stored. This may occur by instructing the hosts to store the buffered data (or the portion thereof relating to the data flow) to persistent memory, or by keeping the buffered data within the buffer and pausing data transmissions, or a combination thereof with different instructions for different hosts. Note that where pause is used, pause time may vary across the different nodes of the cluster, as mentioned above. Regardless of how the data is stored, the netcam may jitter 414 retransmission timing. Recall that the timed sequence of packet transmissions and receptions is reflected in the stored data packets. The netcam may jitter 414 the retransmission timing by altering the timed sequence (e.g., creating longer lag between a previous time gap between transmissions, transmitting the packets in a different order, etc.). The jitter may occur according to a heuristic, or may be random. Jitter is applied in case the prior attempted timed sequence was the cause of the failure (e.g., because the prior attempted timed sequence itself may cause too much transient congestion), and thus the jitter may in such a scenario result in a success where re-transmission without jitter would fail. The netcam then re-transmits 416 the buffered data (or portion thereof). Note that it may be more expedient and computationally efficient to re-transmit the entire buffer, including data unrelated to the data flow or the anomaly, rather than isolating the packets of the data flow that relate to the anomaly. Normal function then resumes until another anomaly is detected.

Re-transmission with jitter is only one example of anomaly function, and any number of functions may occur responsive to detection of an anomaly. For example, additionally or alternatively to the anomaly function depicted in data flow 400, the buffered data may be written to persistent memory and stored for forensic analysis. In such a scenario, responsive to detecting an anomaly, the netcam may transmit an alert to an administrator and/or may generate an event log indicative of the anomaly. Any other aforementioned anomaly function is equally applicable. As an example of forensic analysis, a known type of attack on a system such as a data center is a timing attack. Timing attacks may have “signatures,” in that an inter-packet spacing of traffic can be learned (e.g., by training a machine learning model using timing patterns as labeled by whether the timing pattern was a timing attack, by using pattern recognition, etc.). Forensic analysis may be performed to determine whether the data was a timing attack. Timing attacks may be blocked (e.g., by dropping data packets from a buffer upon netcam module 113 determining that the buffered data represents a timing attack).

As mentioned above, buffered data may include byte stamps (as opposed to, or in addition to, buffered packets). Byte stamps may be used in analyzing an anomaly (e.g., in forensic analysis, network debugging, security analysis, etc.). An advantage of using byte stamps, rather than buffered data packets, is that storage space is saved, and byte stamps are computationally less expensive to process. Byte stamps for an amount of time corresponding to an anomaly may be analyzed to determine a cause of the anomaly. The trade off in using byte stamps, rather than buffered packets, is that buffered packet data is more robust and may provide further insights into an anomaly.

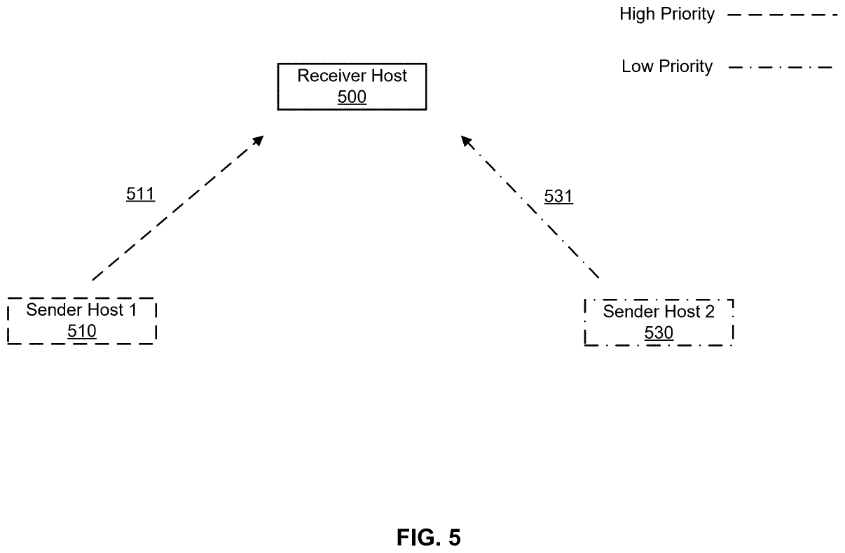

FIG. 5 is a network traffic diagram showing a receiver host receiving both high and low priority traffic from sender hosts, according to an embodiment of the disclosure. As depicted in FIG. 5, sender host 510 transmits high priority data flow 511 to receiver host 500, and sender host 530 transmits low priority data flow 531 to receiver host 500. Where network congestion occurs and an anomaly is detected, the sender hosts may treat the high and low priority traffic differently. In an embodiment, sender host 530 detects network congestion sooner than sender host 510 because low priority data flow 531 is associated with a lower one-way delay threshold than high priority data flow 511. Therefore, sender host 530 may perform remedial action, such as pausing network transmissions of low priority data flow 531, for a pause time, while high priority data flow 511 continues to transmit because its higher one-way delay threshold has not yet been reached. Where high priority data flow 511 does reach its higher one-way delay threshold, and a pause action is responsively taken, that pause time may be lower than the pause time for low priority data flow 531, thus ensuring that high priority data flow 511 resumes sooner and during a time of less congestion than it would face if low priority data flow 531 were not paused for extra time while high priority data flow 511 continued.

Similarly, with respect to shadow buffer operation, a high priority shadow buffer may be separately maintained by receiver host 500 for high priority data flow 511, and a low priority shadow buffer may be separately maintained by receiver host 500 for low priority data flow 531. The drain rate may be weighted differently on the basis of priority. For example, the high priority shadow buffer may have a higher drain rate relative to a drain rate used for the low priority shadow buffer, thus resulting in the high priority shadow buffer being less likely to cause a detection of an anomaly than the low priority shadow buffer.

While depicted as two separate sender hosts, sender hosts 510 and 530 may be a same host, where one sender host transmits both high and low priority traffic to receiver host 500. Thus, a same sender host may take remedial action (e.g., pause) responsive to detecting an anomaly of low priority data flow 531 while continuing to transmit high priority data flow 511 as normal. Sender hosts may have multiple buffers 111, each buffer corresponding to a different priority of data.

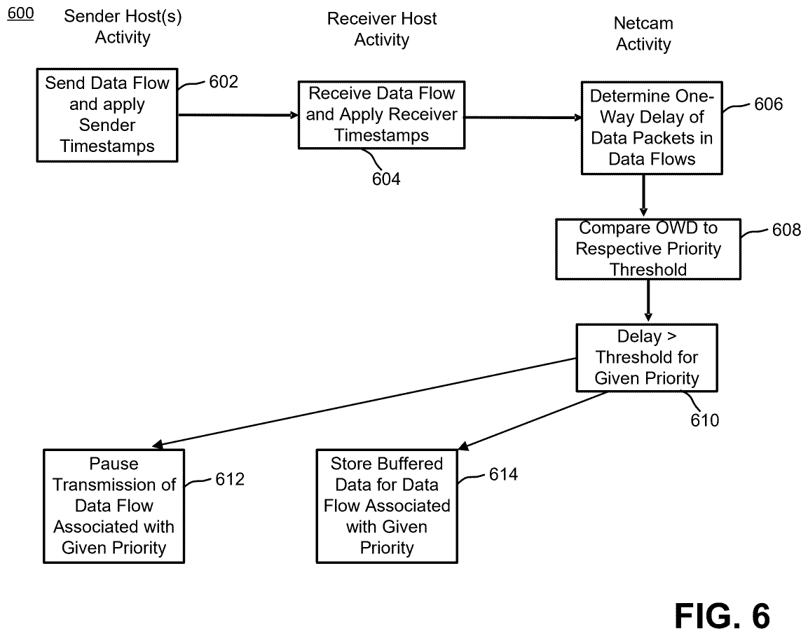

FIG. 6 is a data flow diagram showing netcam activities where priorities are accounted for in determining netcam activity, according to an embodiment of the disclosure.

Data flow 600 begins with one or more sender hosts (e.g., sender host 110) sending 602 a data flow and applying sender timestamps (e.g., sender timestamp 311). A receiver host (e.g., receiver host 130) receives 604 the data flow and applies receiver timestamps (e.g., receiver timestamp 321). Netcam activity then occurs. As described above, the netcam activity may occur at the sender host(s) (e.g., by receiving ACK packets indicating receiver timestamps and using netcam modules to compute one-way delay), at receiver hosts (e.g., where sender timestamps are included in the data flow and netcam modules compute one-way delay therefrom), at netcam system 140, or some combination thereof.

The netcam determines 606 one-way delay of data packets in data flows. As explained above, the one-way delay computation may depend on a priority of the data flow, and thus different data flows may have different one-way delay thresholds (“priority thresholds”). One-way delay may be determined from packets generally, and/or may be aggregated with dwell time to form a shadow buffer one-way delay. The netcam compares 608 the determined one-way delay (or delays, in the case where shadow buffer one-way delay is used) to the respective priority threshold. Responsive to determining 610 that the one-way delay is greater than the threshold for a given priority data flow, anomaly function is initiated. As depicted in FIG. 6, some anomaly function may include one or more of pausing 612 transmission of the data flow associated with the given priority and/or storing 614 the buffered data flow associated with the given priority (e.g., for forensic analysis). As described above, the pause time may vary depending on the priority level of the paused data flow.

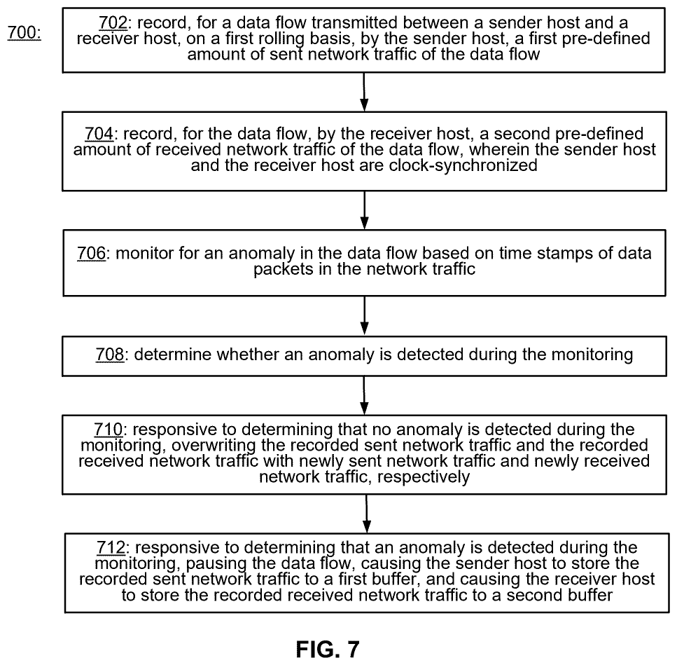

FIG. 7 is a flowchart that illustrates an exemplary process for performing netcam activities, according to an embodiment of the disclosure. Process 700 may be executed by one or more processors (e.g., based on computer-readable instructions to perform the operations stored in a non-transitory computer-readable memory). For example, netcam modules 113, 133, and/or netcam system 140 may execute some or all of the instructions to perform process 700. Process 700 is described with respect to netcam module 113 for convenience, but may be executed by any other netcam module and/or system.

Process 700 begins with, for a data flow transmitted between a sender host (e.g., sender host 110) and a receiver host (e.g., receiver host 130), recording 702, on a first rolling basis, by the sender host, a first pre-defined amount of sent network traffic of the data flow (e.g., recording to buffer 111) and recording 704, on a second rolling basis, by the receiver host, a second pre-defined amount of received network traffic of the data flow (e.g., recording to buffer 131), wherein the sender host and the receiver host are clock-synchronized (e.g., using a reference clock of clock synchronization system 141.

Netcam module 113 monitors 706 for an anomaly in the data flow based on time stamps of data packets in the network traffic (e.g., by subtracting sender timestamp 311 from receiver timestamp 321 and comparing the result to a one-way delay threshold). Netcam module 113 determines 708 whether an anomaly is detected during the monitoring (e.g., based on whether the comparison shows the one-way delay to be greater than the threshold). Responsive to determining that no anomaly is detected during the monitoring, netcam module 133 may passively allow an overwriting 710 of the recorded sent network traffic and the recorded received network traffic with newly sent network traffic and newly received network traffic, respectively (e.g., recording the latest network traffic over the oldest recorded data packet(s) and going on to repeat elements 702-708). Responsive to determining that an anomaly is detected during the monitoring, netcam module 113 pauses 712 the data flow, causes the sender host to store the recorded sent network traffic to a first buffer, and causes the receiver host to store the recorded received network traffic to a second buffer.

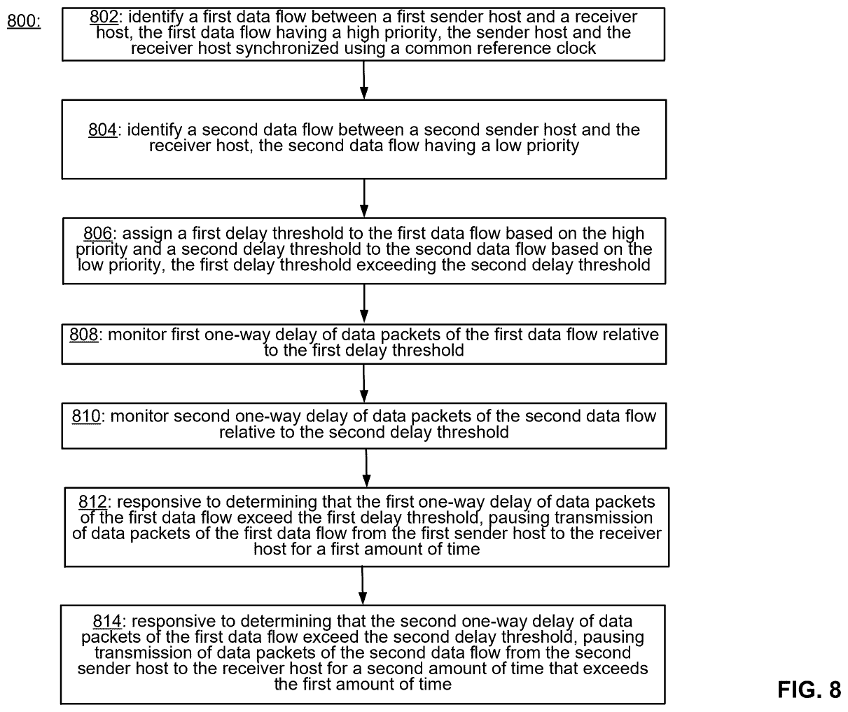

FIG. 8 is a flowchart that illustrates an exemplary process for performing netcam activities in a multiple priority scenario, according to an embodiment of the disclosure. Process 800 may be executed by one or more processors (e.g., based on computer-readable instructions to perform the operations stored in a non-transitory computer-readable memory). For example, netcam modules 113, 133, and/or netcam system 140 may execute some or all of the instructions to perform process 800. Process 800 is described with respect to netcam module 113 for convenience, but may be executed by any other netcam module and/or system.

Process 800 begins with netcam module 113 identifying 802 a first data flow between a first sender host (e.g., sender host 110) and a receiver host (e.g., receiver host 130), the first data flow having a high priority (e.g., high priority data flow 511), the sender host and the receiver host synchronized using a common reference clock. Netcam module 113 (e.g., of a different sender host or a same sender host as sender host 110) identifies 804 a second data flow between a second sender host and the receiver host (e.g., low priority data flow 531), the second data flow having a low priority, where the second sender host may be the same or a different host as the first sender host.

Netcam module 113 assigns 806 a first delay threshold to the first data flow based on the high priority and a second delay threshold to the second data flow based on the low priority, the first delay threshold exceeding the second delay threshold. Netcam module 113 monitors 808 first one-way delay of data packets of the first data flow relative to the first delay threshold, and monitors 810 second one-way delay of data packets of the second data flow relative to the second delay threshold. Responsive to determining that the first one-way delay of data packets of the first data flow exceed the first delay threshold, netcam module 113 pauses 812 transmission of data packets of the first data flow from the first sender host to the receiver host for a first amount of time. Responsive to determining that the second one-way delay of data packets of the first data flow exceed the second delay threshold, netcam module 113 pauses 814 transmission of data packets of the second data flow from the second sender host to the receiver host for a second amount of time that exceeds the first amount of time.

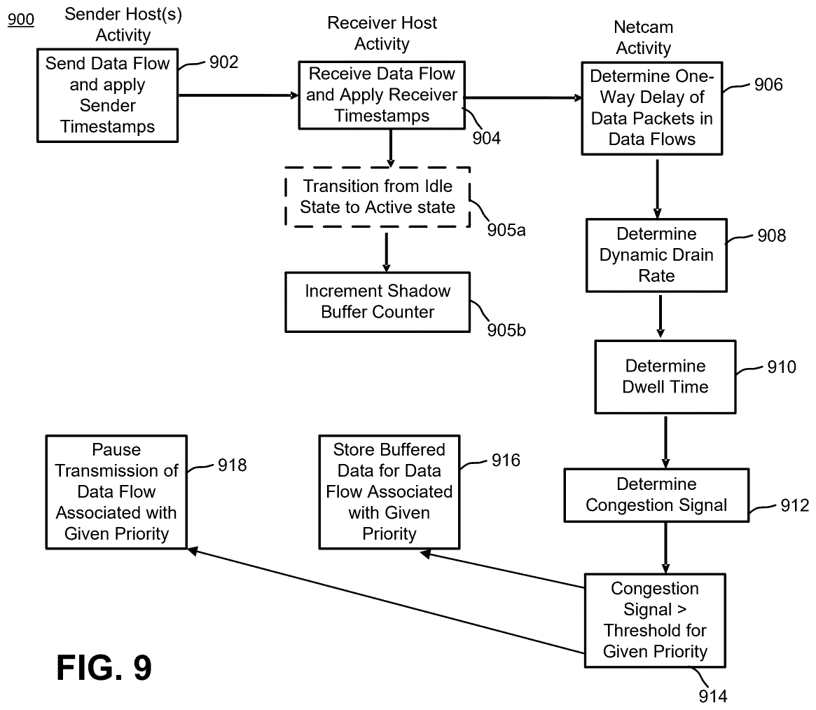

FIG. 9 is a data flow diagram showing netcam activities where shadow buffer considerations are depicted, according to an embodiment of the disclosure. Data flow 900 begins with a sender host sending 902 a data flow and applying sender timestamps, and a receiver host receiving 904 the data flow and applying receiver timestamps. These activities are performed in the manner described above with respect to elements 602 and 604 of FIG. 6. As mentioned with respect to FIG. 1, in an embodiment, the receiver host maintains both one or more regular buffers and one or more shadow buffers, where a regular buffer stores data packets as they are received, and a shadow buffer maintains a counter that ticks up as data packets are received and drains according to a dynamic drain rate (that is, decrements according to the dynamic drain rate over each unit of time). Different shadow buffers may be used for different data flows on a same receiver host, and the different data flows may have different priorities.

A shadow buffer may be in an idle state or an active state. Netcam module 133 of receiver host 130 may determine a shadow buffer to be in an active state responsive to receiving traffic of a data flow (that is, a shadow buffer for that data flow transitions from an idle state to an active state). Netcam module 133 may determine a shadow buffer to be in an idle state responsive to determining that the traffic is no longer received. For example, traffic may be deemed to be no longer received for a data flow where at least a threshold amount of time has passed since a last packet of the data flow was received. As another example, where traffic is consistently received for a data flow on a packet-by-packet basis over each unit of time, and a unit of time passes where a packet is not received for the data flow, netcam module 133 may determine that the traffic is no longer received. Thus, netcam module 133 may continue toggling a state of a shadow buffer for a data flow from idle to active and back depending on whether traffic is received for a data flow. As will be described further below, the state of the shadow buffer is used by netcam module 133 to determine other attributes relating to the shadow buffer, such as drain rate.

Assuming that the shadow buffer was idle, responsive to receiving a first packet of the data flow in 904, netcam module 133 transitions 905a the shadow buffer from an idle state to an active state, and increments 905b a counter of the shadow buffer that indicates a unit of data traffic received. Where the shadow buffer is already in an active state, 905a is not performed, but 905b continues as each unit of traffic (e.g., packet) is received. In an embodiment, netcam module 133 increments the counter by multiplying the unit of data traffic received by a factor. For example, for every packet received, the counter may be incremented by multiplying the unit by a number greater than 1 (e.g., 1.01, or 1.1). As a particular example where there are multiple priorities, if a packet is received, the shadow buffer may be multiplied by 1.01 if it is a high priority flow, or by 1.1 if it is a low priority flow. The higher the factor, the more quickly the shadow buffer counter will have a number that exceeds a threshold reflecting an anomaly (e.g., a scenario that merits pausing traffic and/or performing remedial measures).

The netcam (that is, either netcam system 140 or netcam module 133, or some distributed processing) performs the netcam activity depicted in the right-most column of FIG. 9. For convenience, the activity will be referenced as performed netcam module 133, but distributed or entire processing by netcam system 140 is equally possible.

Netcam module 133 determines 906 a one-way delay of data packets for each data flow, and determines 908 a dynamic drain rate for each shadow buffer corresponding to each respective data flow. While 906 and 908 are depicted sequentially in FIG. 9, these may be performed in parallel with one another or in an opposite order from what is depicted. Element 906 may occur at any point between where it is depicted in FIG. 9 up until the occurrence of 914. Element 906 may be performed in the same manner described above with respect to 606 of FIG. 6.

Netcam module 133 may determine the dynamic drain dynamic drain rate based on a number of units of the data removed from the regular buffer per unit of time while the shadow buffer is in the active state. That is, if three bytes are removed from the regular buffer for transmission to a next node in a data flow per microsecond, then the rate of 3 per microsecond is a basis from which the dynamic drain rate is determined, multiplied by a factor less than 1 (e.g., 0.9 or 0.95) such that drain from the shadow buffer occurs more slowly than drain from the regular buffer. The reason to decrement the shadow buffer at a slower rate than the regular buffer is, again, to ensure that where an anomaly might occur on the regular buffer, it is first detected using the shadow buffer. Netcam module 133 may select a factor to multiply by the drain rate based on priority of data flow, where high priority data flows have higher drain rates (e.g., 0.95-0.99), where medium and low priority data flows have lower drain rates (e.g., 0.9-0.94 for medium and 0.85-0.89 for low).

Netcam module 133 may determine the dynamic drain rate on any cadence, such as each time a data packet is received by receiver host 130, or on a slower cadence, such as for every Nth data packet received in a given data flow. Netcam module 133 may limit performance of determining 908 the dynamic drain rate to scenarios where the shadow buffer is in an active state. Where the shadow buffer is in an idle state, netcam module 133 may render a last determined dynamic drain rate as a static drain rate to use over time to decrement the shadow buffer until such a time that the shadow buffer re-enters an active state, whereafter netcam module 133 may recalculate a new dynamic drain rate.

The dynamic drain rate is used by netcam module 133 for two purposes. First, the dynamic drain rate is used to decrement the shadow buffer counter over time. Second, the dynamic drain rate is used to calculate a “dwell time.” The term dwell time, as used herein, refers to a value that may be aggregated with the actual one-way delay of packets on a data flow as a congestion signal for determining whether there is an anomaly in the data flow that requires remedial measures to be taken.

Netcam module 133 determines 910 the dwell time as a function of the counter of the shadow buffer (e.g., which is a proxy of a length of the regular buffer with some added length based on the incremental and drain multiplier factors) and the dynamic drain rate. In an embodiment, netcam module 133 calculates the dwell time by dividing a value of the counter of the shadow buffer by the dynamic drain rate.

Netcam module 133 determines 912 a congestion signal for the data flow based on the dwell time. In an embodiment, netcam module 133 determines the congestion signal by mathematically aggregating a one way delay between the sender host and the receiver host with the dwell time. Similar to calculating the dynamic drain rate and incrementing the counter, netcam module 133 may weight the dwell time by a factor. For example, the dwell time may be weighted depending on priority of a data flow, where a larger multiplier may be used for lower priority data flows, and a smaller multiplier may be used for higher priority data flows (e.g., 1.01-1.05 for a high priority data flow; 1.06-1.14 for a medium priority data flow; 1.15-1.30 for a low priority data flow). This, again, will cause higher priority data flows to be impacted less frequently than lower priority data flows that will more quickly have their congestion signal reach a threshold that triggers remedial action.

In a similar manner to FIG. 6's discussion of elements 610-614, netcam module 133 may determine 914 that the congestion signal exceeds a threshold (e.g., a priority-specific threshold, similar to that used for regular buffers), and may take remedial action. The remedial action may include storing 916 data or indications of data for the associated data flow, and/or pausing 918 transmission of the associated data flow.

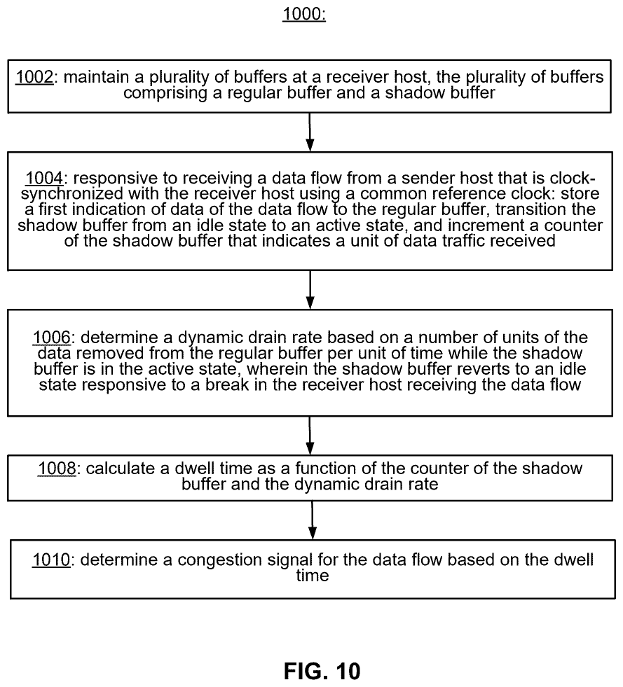

FIG. 10 is a flowchart that illustrates an exemplary process for performing netcam activities in coordination with shadow buffer considerations, according to an embodiment of the disclosure. Process 1000 may be executed by one or more processors (e.g., based on computer-readable instructions to perform the operations stored in a non-transitory computer-readable memory). For example, netcam modules 113, 133, and/or netcam system 140 may execute some or all of the instructions to perform process 1000. Process 1000 is described with respect to netcam module 133 for convenience, but may be executed by any other netcam module and/or system.

Process 1000 begins with netcam module 133 maintaining 1002 a plurality of buffers at a receiver host, the plurality of buffers comprising a regular buffer and a shadow buffer (e.g., buffer 131 and shadow buffer 134). Netcam module 133, responsive to receiving a data flow from a sender host that is clock-synchronized with the receiver host using a common reference clock, performs 1004: storing a first indication of data of the data flow to the regular buffer (e.g., storing a data packet or metadata corresponding to the data packet to buffer 131), transitioning the shadow buffer from an idle state to an active state (e.g., where this is the beginning of traffic in the data flow since a last break in traffic), and incrementing a counter of the shadow buffer that indicates a unit of data traffic received (e.g., counter of shadow buffer 134 that corresponds to the data flow).

Netcam module 133 determines 1006 a dynamic drain rate based on a number of units of the data removed from the regular buffer per unit of time while the shadow buffer is in the active state, where the shadow buffer reverts to an idle state responsive to a break in the receiver host receiving the data flow. Netcam module 133 calculates 1008 a dwell time as a function of the counter of the shadow buffer and the dynamic drain rate, and determines 1010 a congestion signal for the data flow based on the dwell time (e.g., the congestion signal used to detect an anomaly in the same manner described with respect to 708 of FIG. 7).

As mentioned in the foregoing, the embodiments described with respect to FIGS. 1-10 may not be fully efficient in scenarios where long links are deployed. For example, if during a pause (e.g., of 3.2 milliseconds), an MPLS network controller switches a path of the paused traffic link and the switched path has a different latency, then a pause (e.g., applied using element 612 of FIG. 6 or element 918 of FIG. 9) may be applied to a link for which it is not tuned, which creates bandwidth inefficiencies. Systems and methods are disclosed herein for a netcam module implementation that operates efficiently even in long-link scenarios.

Control For Long-Link and/or RDMA Environments

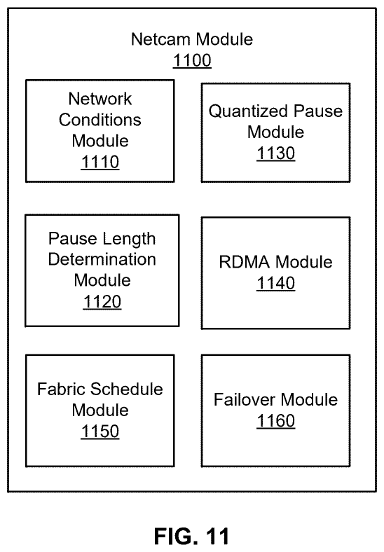

FIG. 11 illustrates exemplary sub-modules of a netcam module for use in a long-link environment, in accordance with an embodiment of the disclosure. As depicted in FIG. 11, netcam module 1100 includes network conditions module 1110, pause length determination module 1120, quantized pause module 1130, RDMA module 1140, utilization module 1150, and failover module 1160. Netcam module 1100 may be any netcam module, such as netcam module 113, netcam module 133, and/or a netcam module implemented by netcam system 140. Processing described as performed by netcam module 1100 may be distributed among any number of netcam modules and netcam system 140 as depicted in FIG. 1.

Network conditions module 1110 determines a set of conditions of the network between a sender host and a receiver host. The determination of network conditions is discussed at length in the foregoing (e.g., determining congestion on a path and/or for a data flow, bandwidth conditions, jitter, and so on; network conditions may also include a priority of a data flow transmitted through a network). As discussed in the foregoing, a shadow buffer may inform network conditions (e.g., by alerting to imminent congestion), and network conditions module 1110 may determine conditions based on this information informed from the shadow buffer.

Beyond determining congestion and the like, network conditions module 1110 may determine whether or not the link is a long link, as this may drive a decision by netcam module 1100 as to whether or not to deploy quantized pausing. To this end, network conditions module 1110 may determine a one-way delay of data traffic between the sender host and the receiver host (e.g., as described with respect to at least FIGS. 3 and 5). Network conditions module 1110 may determine whether the one-way delay exceeds a threshold one-way delay, and responsive to determining that the one-way delay exceeds the threshold one-way delay, network conditions module 1110 may determine that the link is a long link (e.g., which may cause netcam module 1100 to apply a series of quantized pauses rather than one discrete pause, as discussed below). Responsive to determining that the one-way delay does not exceed the threshold one-way delay, network conditions module 1110 may determine that the link is not a long link, and netcam module 1100 may therefore refrain from using quantized pauses. That is, netcam module 1100 may apply a length of pause is completely responsive to determining that the one-way delay does not exceed the threshold one-way delay.

Following a determination of the set of conditions, pause length determination module 1120 may determine a length of pause to apply to the traffic. Pause length may be determined by pause length determination module 1120 in any manner disclosed in the foregoing, such as being predefined by a user, defined based on data type, defined based on a priority of a data flow corresponding to the set of conditions of the network, and so on.

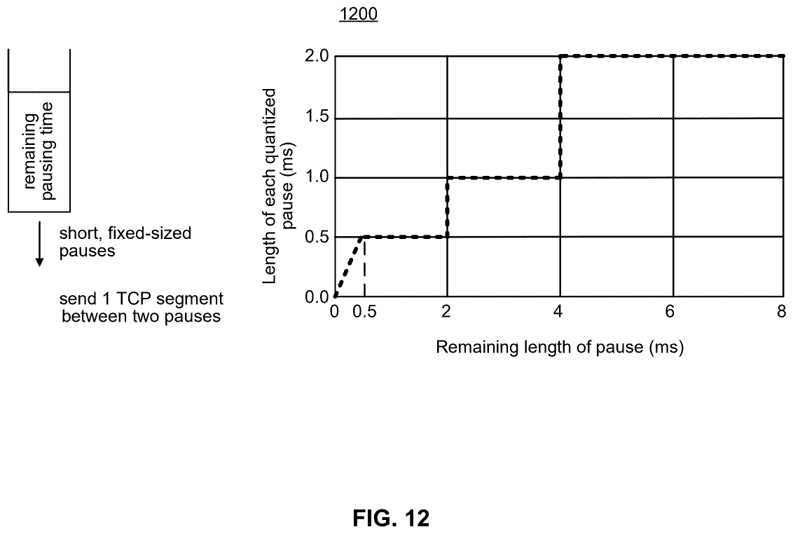

Quantized Pause Module 1130 transmits the traffic using a series of quantized pauses. A unit of traffic may be transmitted between each quantized pause. Turning briefly to FIG. 12 to illustrate the quantized pause concept, FIG. 12 illustrates a graphical depiction of an application for applying quantized pauses, in accordance with an embodiment of the disclosure. As depicted in graph 1200, pause length determination module 1120 may determine if a length of pause is over 4 milliseconds, and may responsively determine that a next pause of the series of pauses for the length of pause will be for two milliseconds. Where the remaining length of pause is between 2 and 4 milliseconds, then a next pause of the series of pauses will be for 1 millisecond. Where the remaining length of pause is between 1 millisecond and 2 milliseconds, the next pause is to be for half a milliseconds. Where the remaining length of pause is a half millisecond or less, then the remainder of the length of pause is applied.

Graph 1200 is merely exemplary, and any function may be applied that dictates how long a next segment of a length of pause should be. That is, graph 1200 represents a step function, where different lengths of quantized pause are applied depending on the remaining pause length. However, the step function is merely exemplary; any function for determining a quantized pause length may be used, such as a linear function, an exponential function, a logarithmic function, a quadratic function, a decay function, and so on.

As depicted in graph 1200, one TCP segment is sent between two quantized pauses. This is merely exemplary, and any unit of any type of traffic (whether TCP or otherwise, such as UDP) may be defined to be sent between quantized pauses. One unit of traffic may be defined to be any amount of traffic that is to be sent between quantized pauses. For example, one unit of traffic may be one data packet, ten data packets, or any number of data packets (or other forms of communication).

Applying these quantized pauses results in many benefits. As one benefit, network control functions will have reduced sensitivity on minimal one-way delay (OWD). For example, to achieve good control, for network controllers operating with the schema described with respect to FIGS. 1-10, OWD threshold needs to be higher than and close to the minimum OWD. However, in long-distance links, the min OWD may fluctuate due to wavelength changes (e.g., triggered by Multiprotocol Label Switching (MPLS)) in optical fibers. In scenarios where the minimum OWD becomes higher than the OWD threshold, network controllers (e.g., described with respect to FIGS. 1-10) may over-pause and cause throughput loss. Thus, monitoring for and transitioning from those embodiments to those of FIGS. 11-13 where long-range links are used results in more efficient bandwidth usage

Moreover, quantized pausing makes these network controllers insensitive to the relationship between min OWD and OWD threshold. Even in scenarios where the minimum OWD is higher, network controllers will not over-pause. Yet further, traffic burstiness is reduced when unpausing. Still further, more information may be conveyed by packet traces, in that a receiving node can analyze a gap between packets to determine if those packets are delayed (the gap is different from those pre-set values) or not. If they are delayed, the receiving node may determine that current throughput equals the bottleneck bandwidth.

Returning to FIG. 11, in order to determine a quantized pause length, quantized pause module 1130 compares the length of pause determined by pause length determination module 1120 to a threshold. The threshold may be determined by a step function, as described above. In some embodiments, rather than using a threshold, a monotonic function or other function may be used. In the case of a step function, in response to determining that the length of pause exceeds the threshold, quantized pause module 1130 may instruct the sender host to pause the traffic for a first amount of time. In response to determining that the length of pause does not exceed the threshold, quantized pause module 1130 may instruct the sender host to pause the traffic for a second amount of time smaller than the first amount of time. To illustrate this, following from FIG. 12, the threshold may be 2 ms, where a quantized pause of 1 ms is selected if the pause length exceeds 2 ms, and where a quantized pause length of 0.5 ms is selected if the pause length does not exceed 2 ms.

In some embodiments, quantized pauses may be occurring in rapid succession, which causes a requirement that units of traffic be transmitted without delay. Moreover, because the quantized pauses are occurring on data flows that have congestion, other traffic, such as acknowledgments for receipt of a given unit of traffic, may be delayed. Thus, in some embodiments, following each given quantized pause of the series of quantized pauses, a next unit of traffic may be transmitted without reliance on receipt of an acknowledgement packet from the receiver host for a prior unit of traffic that was transmitted prior to the given pause. This ensures that each unit of traffic is timely transmitted according to the quantized pause schedule.

Quantized pause module 1130 may detect a new set of conditions of the network between the sender host and the receiver host, and may apply a new series of quantized pauses to transmission of the traffic based on a new length of pause determined from the new set of conditions. In some embodiments, quantized pause module 1130 may perform this detection by receiving an alert from network conditions module 1110 that the conditions have changed. The alert may be unsolicited by quantized pause module 1130. Alternatively, quantized pause module 1130 may request an alert when conditions change, and/or may expressly request a determination of conditions at certain trigger points (e.g., periodically, after a certain number of quantized pauses occur in a series, are at any other trigger points), and may receive the results of the determination at those times. Thus, quantized pause module 1130 may, before transmitting a quantized pause series for the full amount of a pause length, may cause a redetermination of the length of pause based on a redetermination of the set of conditions of the network (e.g., each time a predefined number of quantized pauses occur).

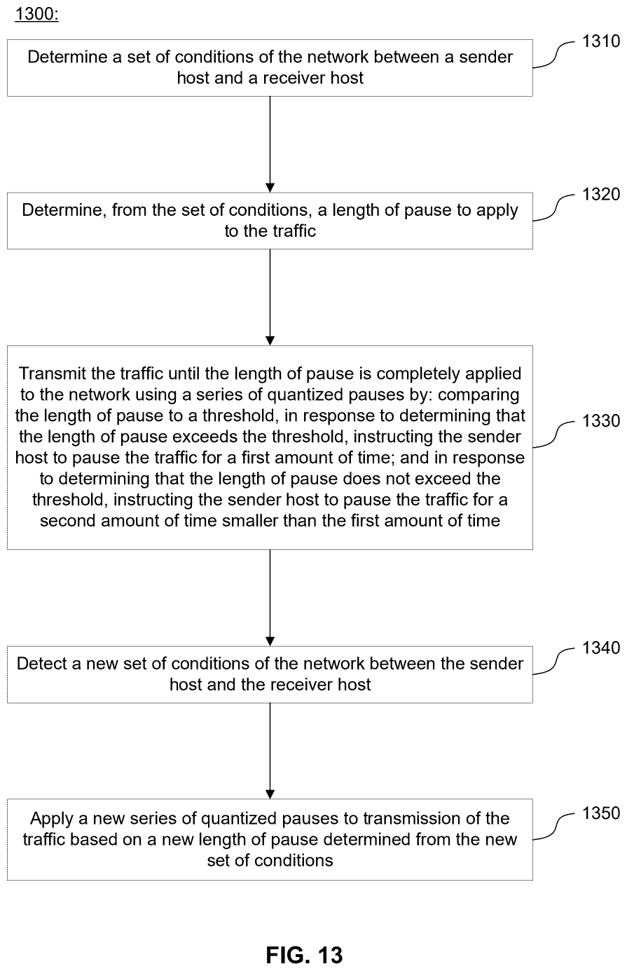

FIG. 13 is a flowchart that illustrates an exemplary process for deploying quantized pauses in connection with netcam activities on long-range links, in accordance with an embodiment of the disclosure. Process 1300 may be performed by one or more processors executing instructions that cause netcam module 1100 to perform operations. Process 1300 may begin with netcam module 1100 determining 1310 a set of conditions of the network between a sender host and a receiver host (e.g., using network conditions module 1110 to detect conditions between one or more sender hosts (e.g., 210, 220, 230, 310 etc.) and a receiver host (e.g., receiver host 200 and/or 320).

Netcam module 1100 may then determine 1320, from the set of conditions, a length of pause to apply to the traffic (e.g., using pause length determination module 1120). Netcam module 1100 may transmit 1330 the traffic until the length of pause is completely applied to the network using a series of quantized pauses (e.g., using quantized pause module 1130). This may be performed by comparing the length of pause to a threshold, in response to determining that the length of pause exceeds the threshold, instructing the sender host to pause the traffic for a first amount of time, and in response to determining that the length of pause does not exceed the threshold, instructing the sender host to pause the traffic for a second amount of time smaller than the first amount of time (e.g., using the step function described in graph 1200).

Netcam module 1100 may detect 1340 a new set of conditions of the network between the sender host and the receiver host (e.g., using network conditions module 1110), and may apply 1350 a new series of quantized pauses to transmission of the traffic based on a new length of pause determined from the new set of conditions (e.g., using quantized pause module 1130).

Returning to FIG. 11, RDMA module 1140 may be used to determine one-way delay for application layer messages without passing through the kernel by using Remote Direct Memory Access (RDMA). In some embodiments, to synchronize system clocks, software timestamps may be taken over TCP/UDP. In other embodiments, NIC clocks are synchronized, where a system clock is a follower of a NIC clock. However, in both of these embodiments, latency is incurred by passing messaging through the OS stack, which in turn adds noise to one-way delay (OWD) measurements. RDMA module 1140 improves on these embodiments by bypassing the OS kernel in determining and communicating timestamps for application layer messaging. More particularly, RDMA module 1140 achieves, by using RDMA, system clock timestamping without using the NIC clock. Instead, RDMA module 1140 has the NIC read the system timestamp from memory, and to write the system timestamp to memory in a location that can be accessed by a receiver host using RDMA, thereby enabling one-way delay measurements without incurring OS latency.

In some embodiments, RDMA module 1140 identifies a metadata field within a Remote Direct Memory Access (RDMA) message structure that can be used for timestamp injection. RDMA module 1140 may identify the metadata field based on data within a payload of the RDMA message, where the metadata field points to that data.

RDMA module 1140 may generate a high-resolution timestamp that captures a time when the RDMA message is sent. The high-resolution timestamp may include a time stamp having large granularity (e.g., timestamp accurate to an order of nanoseconds or even more granular). For example, the timestamp may, at a high-resolution, take up 64 bits or beyond. RDMA module 1140 may capture the timestamp from a system clock of a sender host that is in communication with a receiver host and that is transmitting application-layer messages to the receiver host.

RDMA module 1140 may compress the high-resolution timestamp into a compressed (e.g., low-resolution) timestamp that fits within the size of the metadata field. For example, a metadata field of an RDMA message may be limited to 32 bits. Therefore, where a timestamp takes up to 64 bits to communicate, the timestamp would not fit in the metadata field. RDMA module 1140 may compress the high-resolution timestamp to a compressed timestamp that fits within the metadata field without sacrificing so much resolution that a one-way delay calculation accuracy is compromised.

In some embodiments, RDMA module 1140 may compress the high-resolution timestamp into the compressed time stamp by truncating the timestamp to reduce the size of the high-resolution timestamp to the size of the metadata field. For example, where a timestamp is accurate to an order of nanoseconds, the timestamp may be truncated to a nearest microsecond or millisecond-whatever fits within the size constraints of the metadata field.

In some embodiments, RDMA module 1140 may compress the high-resolution timestamp into the compressed time stamp using deltas. That is, RDMA module 1140 may, for each subsequent timestamp, determine a difference between the high-resolution timestamp and an immediately prior high-resolution timestamp and generate the compressed time stamp to indicate the difference, the difference being small enough to fit within the metadata field. RDMA module 114 may generate a reference by first sending a high-resolution timestamp to the receiving host as a reference for decoding the difference. This may be sent in any known mechanism, such as sending the high-resolution timestamp in an out-of-band message, a message header, a message payload, etc. Subsequent messages may then simply include the difference between the prior message's timestamp and the current message's timestamp, where the receiver may reconstruct the exact timestamps using an addition operation. RDMA module 1140 may, periodically or according to an algorithm, determine to send high-resolution timestamps from time to time in order to ensure accuracy of the high-resolution timestamp (e.g., to prevent impact from undetected clock drift).

In some embodiments, compressing the high-resolution timestamp into the compressed time stamp may include truncating the high-resolution timestamp into the compressed timestamp. RDMA module 1140 may generate a truncated timestamp by truncating most-significant bits of the high-resolution timestamp necessary to reduce the first size to the second size, and may use the truncated timestamp as the compressed timestamp. Examples of where this method of compression may be useful is where timestamps are measured to microseconds for their downstream purpose. For example, where one-way delay is being calculated for the purpose of clock synchronization, micro-second accuracy may be sufficient. Following from an earlier example, where the metadata field size is 32 bits, micro-second resolution fits within the metadata field size. 32 bits is sufficient to represent any value from 0 microseconds to 4 seconds, and therefore is sufficient for one-way delay calculations (that is, subtracting transmit timestamps from receiver timestamps) so long as delays are expected to be less than 4 seconds, meriting this form of compression in such a scenario.

RDMA module 1140 may inject the compressed timestamp into the metadata field of the RDMA message for sending from a sender host to a receiver host. That is, the compressed timestamp may be written to memory and smuggled into the metadata field of an application-layer message when sent from the sender host to the receiver host. The receiver host may then have its NIC perform a DMA operation to read the metadata and save it to local memory for a one-way delay calculation, which in turn enables the receiver host to calculate one-way delay between the sender host and the receiver host using the compressed timestamp in any manner discussed in the foregoing. In some embodiments, netcam module 1100 may output a control signal based on the one-way delay to perform a coordinated control operation. In some embodiments, the control signal may be for synchronizing clocks of the sender host and the receiver host (e.g., as discussed in reference application U.S. Pat. No. 10,623,173, issued Apr. 14, 2020, the disclosure of which is hereby incorporated by reference herein in its entirety, the one-way delay used as the measured drift and/or offset discussed in the reference application).

### Fabric Scheduling and NIC Failover Mechanisms

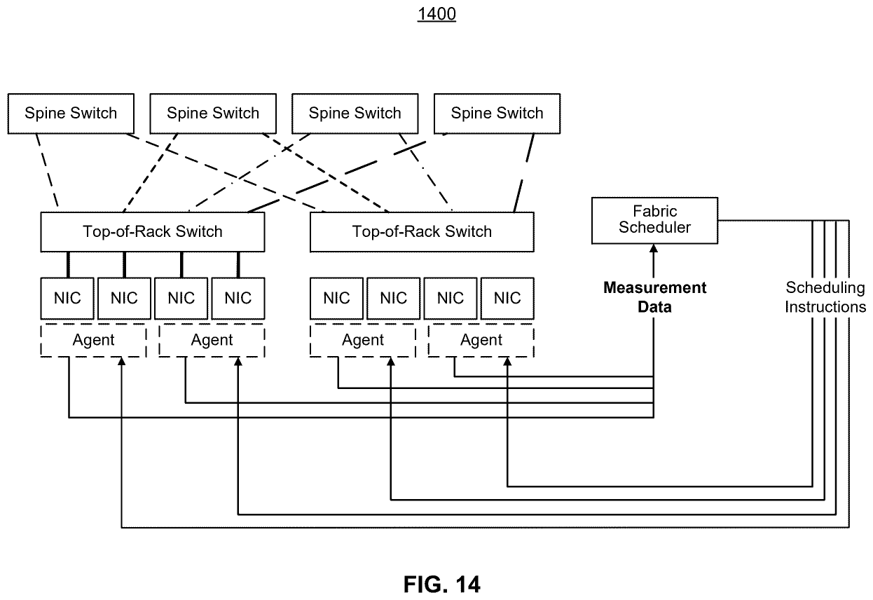

FIG. 14 is a network diagram for an exemplary multi-stage interconnection network, in accordance with an embodiment. As depicted in FIG. 14, interconnection network 1400 includes a fabric scheduler, agents with corresponding NICs, and paths through various network components including a top-of-rack switch and a spine switch, though any other switches, gateways, and other network components not depicted may be present. The fabric scheduler may perform any network coordination activity or coordinated control activity, as described with respect to netcam system 140 and/or netcam modules 113 and 133. While depicted as a centralized entity, the fabric scheduler may be present on one or more individual agents, as described with respect to netcam module 113 and netcam module 133. The agents may be sender hosts (e.g., sender host 110) and/or receiver hosts (e.g., receiver host 130). The NICs may be part of their respective hosts (e.g., NIC 112 and NIC 132). The switches may be part of, e.g., network 120.

Fabric schedule module 1150 may, in the context of interconnection network 1400, coordinate scheduling of data flows through interconnection network 1400. To perform this scheduling, fabric schedule module 1150 may detect paths used by the application through the network and detect other link quality metrics using a probe mesh. Fabric schedule module 1150 may determine link utilization for each path, and may coordinate traffic scheduling based on the utilization. Fabric schedule module 1150 implements an edge-based method that does not require collection of measurements by the switches of interconnection network 1400.

In order to detect paths and link quality metrics used by an application layer, Fabric schedule module 1150 may leverage rules of application layer network transmissions. For example, in routing strategies such as ECMP (Equal-cost multi-path routing), the route taken by traffic is determined by a hash on the 4-tuple defining the connection parameters: (Source IP, Source Port, Destination IP, Destination Port). For such routing strategies, this invention disclosure defines a method and system to (1) determine per-link bandwidths and (2) use that information to schedule traffic., Fabric schedule module 1150 may, for each respective flow over a network initiated by an application layer.

Fabric schedule module 1150 may detect paths and link quality through a probe mesh. The term probe, as used herein, may refer to a packet used to determine OWD on a link. The term probe mesh refers to the aggregate information observed by transmitting probes through the network. The fabric schedule module 1150 creates the probe mesh by sending small packets via standard Unix sockets, IB verbs, or any other end-to-end communication library. This probe mesh will work on any kind of network: for example, InfiniBand networks, RoCE networks, TCP/IP over Ethernet networks, or any other kind of network. The probe mesh sweeps 4-tuples and determines (1) the space of possible paths in the network that connect edge NICs (e.g., as depicted in FIGS. 14), and (2) one-way delays and ECN (Explicit Congestion

Notification) counts on those paths. Fabric schedule module 1150 may calculate one-way delay across a path in any manner discussed in the foregoing. Common route-detection tools (e.g. traceroute) can provide the exact path that the probes on each connection take. Link quality may be determined based on OWD and ECNs, among other characteristics.

Following determining all paths used by the application layer, fabric schedule module 1150 determines utilization for each path. In an embodiment, fabric schedule module 1150 performs a direct measurement of link utilization. In such an embodiment, a data path sensor reports the throughput of individual end-to-end connections. This sensor can be a custom NCCL plugin or any other middleware that sits in between the application and the data path (e.g. IB/ROCE) library calls. Since the 4-tuple of each connection is known, the path of each of these connections is provided through traceroute. Fabric schedule module 1150 may determine the utilization based on a comparison of the throughput relative to the bandwidth capacity of the path.

In an embodiment, fabric schedule module 1150 may determine the utilization by way of performing an estimation from probes, where the probe mesh is used to estimate the link utilizations. In cases where a switch simultaneously serves multiple flows, the link utilization can be estimated by the probability that a given probe encounters queueing. On a particular path x, let Pₓ be the probability of a probe encountering queuing at one or more switches and let Pᵢ be the probability that a probe encounters queueing at switch i. Then,

$${P}_{x} = 1 - {\prod }_{i = 1}^{n} [ i ϵ x ] ( 1 - {P}_{i} )$$

For all paths x, transforming the above into log space can provide a system of linear equations. Solving this system of linear equations yields the estimated utilization at each switch.

$$log ( 1 - {P}_{x} ) = {\sum }_{i = 1}^{n} [ i ϵ x ] log ( 1 - {P}_{i} )$$

In order to determine scheduling, fabric schedule module 1150 determines an optimal usage across each path. The manner of determining optimal usage depends on whether the coordinator operates as a central fabric scheduler, or whether agents make local scheduling decisions using only data that they have. Hybrid approaches are possible, where cliques of agents exchange information and make semi-local scheduling decisions. For example, a hybrid approach may include a group of central fabric schedulers, each of which applies to a particular subset of nodes on the network. The group of central fabric schedulers may be hierarchical to accommodate scales at which it is impractical for a single fabric scheduler cannot communicate with all nodes (e.g. “ground-level” fabric schedulers provide instructions directly to end hosts, while “top-level” schedulers can provide information to the ground-level schedulers).

In scenarios where there is a central fabric scheduler, a central fabric scheduler receives the above real-time measurement data from a set of agents. The fabric scheduler performs the necessary computations to determine link-level bandwidths and bandwidth-maximizing routes for any given source or sink. Consider a topology of N nodes {1, . . . , n}. These nodes can be NICs or switches. The data path sensor and probe mesh will provide:
A set of matrices {P₁, . . . . Pₖ}, where Pᵢ∈{0,1}^{n×n}, each of which describes a path between two NICs. In each of these matrices, 1 encodes the presence of an edge, while 0 encodes the absence of an edge. Every path will involve exactly two NICs and some number of switches.
A set of utilizations {U₁, . . . , Uₖ}, where Uᵢ∈ [symbol] , which is in Gbps.

The agents of interconnection network 1400 will compute U and P and send this data to the coordinator. Then, the usage of each link in the network is given by a matrix W∈ [symbol] ^{n×n} which can be computed by the coordinator:

$$W = {\sum }_{i ϵ \{ 1 , … , k \}} {U}_{i} {P}_{i}$$

If B is the matrix of available bandwidth on each link, then the available capacity on each link is defined by C=B−W. Then, given source NIC i and a destination NIC j, the optimal allocation of routes can be computed by applying a max-flow algorithm on inputs (C, i, j). After the optimal path is computed, it is sent back to the agents for use.

Where local scheduling is performed by one or more agents, the local scheduling can occur in two phases: Byte-Balance and Route-Scout.

Where a Byte Balance approach is used, at any given moment, the agent maintains several queue pairs (QPs). Queue Pairs describe two queues, including a send queue and a receive queue, where the send queue handles outgoing data and commands, and the receive queue manages incoming data. Work requests are submitted to the queue pairs to perform individual DMA operations. This is analogous, in a DMA environment, to pairs of NICs that form paths where the agents corresponding to the NICs of the pair are sender and corresponding receiver hosts for a given data flow. The fabric scheduler evaluates each QP according to metrics. Example metrics may include a number of packets with an ECN mark signaling that congestion has been encounter, one-way delay measurements using NIC timestamps to cut out stack latency, and any other metrics as compared to, e.g., a rubric for performance relative to each metric. The metrics may, in some embodiments, be provided by the Shadow Queue pair that takes the same route as the original (described in further detail below).

The fabric scheduler determines a weight associated with the QP based on the evaluation. Then, traffic is sent on this QP in proportion to the weight that it has. The traffic balance between the QPs is iteratively adjusted until an equilibrium is reached. Where a Route Scout approach is used, when the equilibrium weights in byte balance produce a combination that is still not optimal (e.g. some signal such as delays or ECNs indicates that further improvement is possible), the coordinator creates a new QP (that has a different route though the network). If the newly created QP is better than the worst of the existing QPs (e.g., in terms of ECN/OWD metrics), the coordinator shifts traffic onto the new one, discarding the worst one. To determine whether the combination is optimal, in steady state, the proportion of ECN-marked packets equalize (e.g., with some threshold tolerance for variation) between the paths. If not, there is further balancing to be done because some paths are still better than others. Once in a balanced state, if the number of ECNs is still non-zero, the coordinator scouts for new routes to achieve further improvement (e.g., using Route Scout). If all ECNs are zero, no further improvement is possible.

Following determining optimal paths having optimal queue pairs, the fabric scheduler schedules transmission of data for each respective flow based on the optimal usage. In some embodiments, a network may be oversubscribed (for example, there exists more capacity in the spines than the NICs can produce, even if each is sending at 100% utilization). In such cases, the fabric scheduler can provide recovery from failed links, so that each NIC can still send at 100% even if some network internals have failed. For example, where the coordinator detects an internal link between switches is down based on no probes succeeding, the probe mesh may give all routes that use this link a capacity of 0, resulting in the flow scheduler adjusting to route all traffic away from the broken link. The fabric scheduler may additionally or alternatively perform spatial speedup to achieve higher throughput (e.g., by moving traffic away from links where throughput is approaching or exceeding 100% utilization).

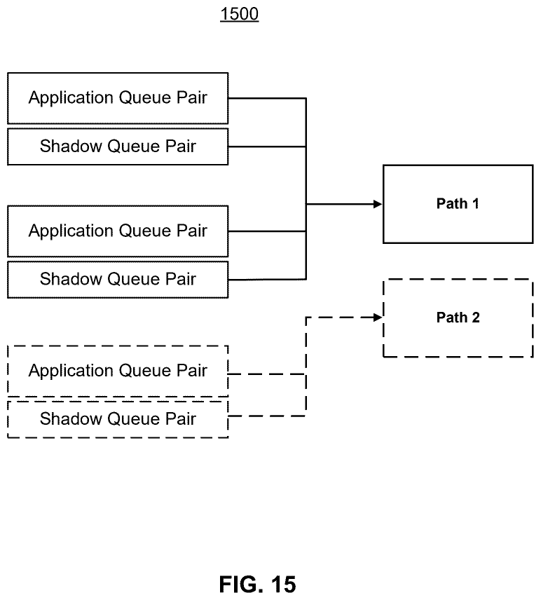

In some embodiments, the fabric scheduler may form shadow queue pairs. While QPs form traditional application layer connections (e.g., TCP connections, shadow QPs form similar pairs but for RDMA networks, and are a manner in which two NICs can communicate using low-overhead that is guaranteed to follow the same path as its corresponding QP. Turning to FIG. 15, FIG. 15 shows exemplary shadow queue pairs instructed to follow paths of their corresponding application queue pairs. Illustration 1500 shows that if there are 3 application QPs, and each is assigned a shadow QP, the first two application QPs take path 1. Their corresponding shadow QPs are instructed to ensure that they are forced to communicate down the same path. Shadow QPs can, with lower overhead than QPs, provide metric information used in byte balancing and route scout approaches. For example, shadow QPs can provide real-time measurements of OWD and ECN in order to inform path quality. In some embodiments, the implementation of Shadow QPs relies on the use of UD (Unreliable Datagram) Queue Pairs, which expose the IP header of the packet on the receiver side. Parsing this header provides the ECN bits. Furthermore, use of NIC hardware timestamps provides accurate OWD measurements.

Another source of information for scheduling and routing is the detection of ECN bits through sniffing data packets. We use Open vSwitch NIC offload to configure OpenFlow policies at the end host, so that the end host can selectively mirror the ECN marked packets to a VF (virtual function) port. The fabric scheduler may deploy an ECN scraper that iterates through each VF interface, so that the fabric scheduler can then calculate the ECN stats corresponding to each interface. Specifically, the fabric scheduler is enabled to keep track of the number of packets marked with the CE (Congestion Encountered) signal per source port (e.g., for byte balancing and route scouting as mentioned in the foregoing.

Using the fabric scheduler in LLM environments leads to advantages because LLM buffers are expensive and shallow, causing differences between congested traffic and uncongested traffic to be difficult to detect. Because there is almost no buffering in LLM environments, without a central or hybrid central fabric scheduler, it is not possible to know what paths have congestion. However, with the fabric scheduler, it is possible to know utilization of data links, thereby enabling different scheduling decisions to be made on the basis of utilization. Moreover, in typical LLM environments, redundancies are typically in place, such as having an additional spine switch in case one spine switch fails. These redundancies can be used by the fabric scheduler to perform spatial speed-up, where traffic destined for congested links can be redirected to decongested or unused links.

Returning to FIG. 11, failover Module 1160 works with Network Condition Module 110 to mitigate payload failures at NICs in a networked computing environment. In some embodiments, the failover module 1160 continuously monitors one or more health metrics of the network to detect payload failures along different network paths, including payload failures at a NIC (e.g., NICs 112A, 112B, 132A, 132B in FIG. 1). For example, NICs 112A and 132A may be primary NICs. NICs 112B and 132B may be backup NICs.

In some embodiments, the one or more health metrics include at least a timeout in data transmission, an error in sending or receiving data, or a completion queue status. In some embodiments, a central system (e.g., a centralized fabric scheduler in FIG. 14 or netcam system 140 in FIG. 1) may aggregate data from across the network to determine path health. This central system collects and processes metrics from agents on all hosts (e.g., netcam module 113, 133 in FIG. 1, and agents in FIG. 14) to determine the network health. In some embodiments, NIC hardware timestamps are used to measure one-way delays, and the one-way delays are served as a proxy for assessing the quality of network paths. In some embodiments, the one or more health metrics are obtained from one or more of a probe mesh, shadow queue pair, application level indicators, and a centralized scheduler.

As described above with respect to FIGS. 1-15, a probe mesh includes a collection of agents deployed throughout the network. In some embodiments, each netcam module 113 or 133 includes an agent. These agents are responsible for actively sending RDMA messages across different network paths. Each agent in the probe mesh sends test data packets along predetermined or dynamically selected network paths that connect various network components, such as NICs or servers. These test packets help to verify the operational status of each path, checking for issues like latency, packet loss, or any other factors that might indicate a problem or potential bottleneck. In some embodiments, the probe mesh evaluates the performance of network paths based on the success or failure of these test transmissions. A path may be considered healthy if the RDMA messages pass through without errors and within acceptable performance thresholds. This ongoing assessment helps in preemptively identifying issues before they impact normal network operations, allowing failover module 1160 to intervene and make necessary switches. In some embodiments, data gathered by the probe mesh may be relayed to the netcam system 140 or the clock synchronization system 141, which uses this information to make decisions about data routing, load balancing, and/or failover management. In some embodiments, the probe mesh may also help in validating the health of paths post-fail-over, ensuring that the backup NIC is properly reintegrated into the network traffic flow.

A shadow queue pair is a network monitoring and management tool used within the system to test and validate network paths, similar to the probe mesh. A shadow queue pair includes one or more unreliable datagram (UD) queue pairs that are configured to mirror activities of primary queue pairs within the network. These shadow queue pairs are used to send data along one or more network paths to determine the health and viability of these paths. The shadow queue pair can simulate normal data traffic without impacting the actual data being transmitted, thus providing a real-time, non-disruptive way to test network paths. In some embodiments, shadow queue pairs operate by duplicating the communication patterns of regular, operational queue pairs but use separate resources to avoid interfering with operational data flows. This duplication allows shadow queue pairs to send test data along the same paths as the operational data, effectively shadowing the live network traffic. The system can assess path health by attempting to transmit data and monitoring the success of these transmissions, checking for errors, latency, and other performance metrics that could indicate potential issues.

Application-level health indicators are metrics or signals derived from upstream applications themselves, rather than from the underlying hardware or network infrastructure. These indicators can also be used to help determine the operational status and health of network paths in real-time. The application-level health indicators may include (but are not limited to) data and control payload timeouts, and completion queue errors, among others. Data and control payload timeouts indicate the time it takes for data or control commands to be processed or acknowledged within an application. Excessive timeouts may signal that an application is unable to process incoming data efficiently, possibly due to network congestion, resource limitations, or internal application errors. Completion queue errors may be obtained by checking the error rates and statuses within completion queues that manage the communication between network devices and the application. Errors can indicate problems such as misconfigurations, exceeded capacity, or faulty interactions with the network.

### Example Methods for Mitigating Payload Failure

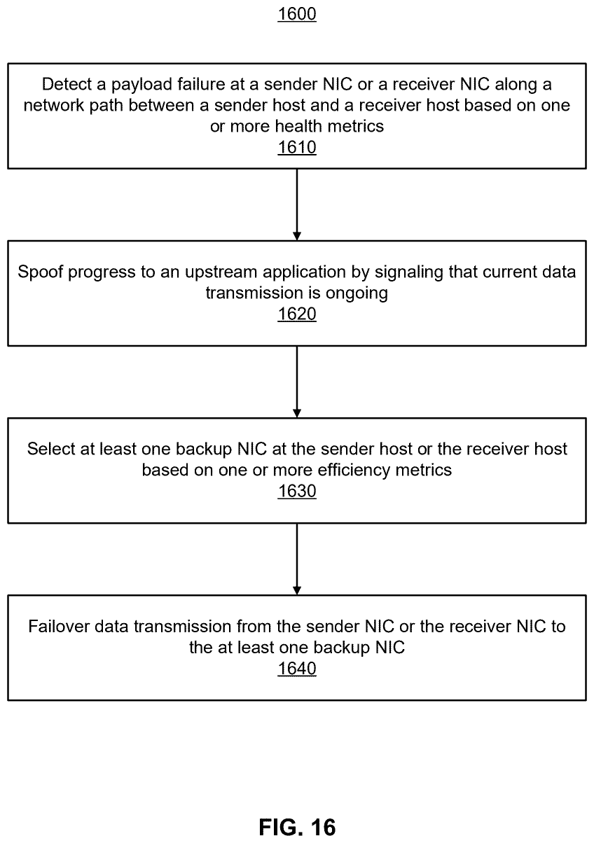

FIG. 16 is a flowchart that illustrates an example process 1600 for mitigating payload failures at NICs in a networked computing environment in accordance with one or more embodiments. The operations shown in FIG. 16 may be performed by a system including one or more components of a sender host, receiver host, netcam module, fabric scheduler, or a combination thereof. In various embodiments, the illustrated steps may be executed in a different order than presented, and some steps may be optional, omitted, or combined. Additional steps not explicitly shown may also be included depending on system configuration, deployment environment, or application requirements.

The failover module 1160 detects 1610 a payload failure at a sender NIC among multiple sender NICs or a receiver NIC among multiple receiver NICs along a network path between a sender host and a receiver host based on one or more health metrics. The health metrics monitored by the failover module may include transmission timeouts, completion queue errors, excessive packet loss, one-way delay anomalies, and other network-level indicators of degradation or failure. These metrics can be gathered from local NICs, system logs, or external monitoring systems such as a centralized netcam system or probe mesh infrastructure. The detection process may be proactive or reactive, identifying symptoms of failure before a complete breakdown or immediately after an error occurs. The failover module may use threshold values to determine when a NIC's behavior deviates from expected norms. By continuously monitoring these metrics across all NICs in use, the failover module ensures early detection of faults, enabling the system to initiate corrective measures before data integrity or application performance is compromised.

Responsive to detecting a payload failure, the failover module 1160 spoofs 1620 progress to an upstream application by signaling that current data transmission is ongoing, such that the upstream application does not detect the payload failure. An upstream application in the context of networked computing environments refers to a software application that relies on data from lower-level or downstream network components within a network infrastructure. The upstream application operates at a higher level in the data processing hierarchy, relying on the successful operation and data delivery from downstream components to function correctly. For example, an upstream application may be a server that consumes data transmitted by downstream network elements, such as NICs.

Note, in existing systems, without spoofing progress, the upstream application would directly experience disruptions when a current network path is replaced with an alternate network path, e.g., a current NIC is replaced with a backup NIC. This disruption could lead to abrupt application errors, crashes, or freezes. The upstream application may be required to reboot, which could result in minutes or hours of interruption of service. The embodiments described herein spoof the progress of data transmission, which allows for issues to be resolved in the background, maintaining a seamless user experience.

In some embodiments, the multiple NICs at the sender host or receiver host may include a primary NIC and one or more backup NICs. Responsive to determining payload failure at the primary NIC, the failover module 1160 selects 1630 one of the backup NICs based on one or more efficiency metrics of each of the backup NICs. The one or more efficiency metrics include a proximity metric and a utilization metric. A proximity metric measures the physical or logical distance between components within the network, such as distances between NICs and central processing units (CPUs), graphic processing units (GPUs) and/or memory resources. For example, the proximity metric may include a non-uniform memory access (NUMA) distance to measure a distance between a NIC and a memory resource. Because data transmission speeds and latency can be affected by the distance data must travel across the network hardware, the proximity metric can be used to identify a NIC that can provide faster data transmission with lower latency. For example, a NIC that is physically closer to a specific processing or memory resource might be preferred because it can potentially offer lower latency and faster data transfer speeds.

A utilization metric measures traffic being handled by network components such as NICs. Utilization metrics may include (but are not limited to) measures of current bandwidth usage, packet rates, error rates, and overall capacity utilization. A backup NIC with lower utilization might be selected to ensure that the failover does not overwhelm the selected backup NIC.

In some embodiments, the selection of a backup NIC may apply a balanced approach, where both metrics are used in conjunction to make the selection. For example, a backup NIC might be chosen based on a favorable proximity metric, but only if its utilization metric indicates that it has sufficient capacity to handle additional traffic without compromising performance. By considering both proximity and utilization, the failover module 1160 can optimize the layout and usage of network resources, enhancing overall reliability and performance of the network.

In some embodiments, multiple NICs at the sender host or receiver host are selected to redistribute application workloads across multiple NICs within the same host to optimize performance and reduce peripheral component interconnect express (PCIE) contention. PCIE contention refers to a scenario where multiple devices or processes compete for limited bandwidth or resources on the PCIE bus. Contention may occur when multiple devices try to transmit data simultaneously over the same bus, leading to potential bottlenecks. This can reduce the overall performance and efficiency of data transfer within a network system, especially in environments with high data throughput demands. In some embodiments, the failover module 1160 dynamically spreads the traffic across different NICs based on their current utilization and proximity to relevant processing units. By doing this, it avoids overburdening any single NIC, which can help prevent PCIE bottlenecks that occur when too much data traffic is routed through a single point. This balancing act takes into account the existing traffic load on each NIC, ensuring that none are idle while others are overloaded.

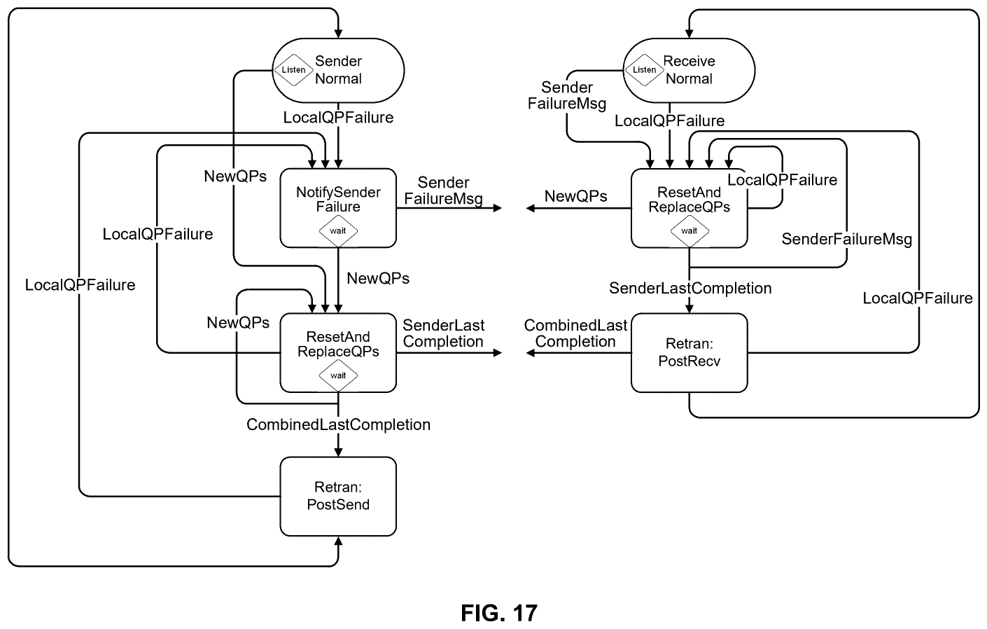

Responsive to selecting a backup NIC, the failover module 1160 failovers 1640 data transmission from the primary NIC to the selected backup NIC. In some embodiments, failing over data transmission from the primary NIC to the selected backup NIC includes transitioning all queue pairs between the sender host and the receiver host to a RESET state. Queue pairs manage the communication between NICs on sender and receiver hosts. They typically have several states, including active, inactive, and RESET states. Transitioning to RESET disables the queue pairs from processing any further data and clearing their memory buffers. This process might involve sending specific commands from the network controllers or management modules (like the fabric scheduler or the netcam system) to each NIC involved in the data transmission. These commands instruct the NICs to discontinue their current operations and reset their states. Transitioning queue pairs to a RESET state clears any existing configurations, pending operations, or data remnants that might be corrupted or stale due to the payload failure, which may be caused by hardware failures, congestion, or other disruptions. The RESET action reinitializes both the sender and receiver hosts, thereby preventing the propagation of errors and ensuring that new, healthy configurations can be applied. Additional details about failover data transmission from one NIC to another NIC are further described below with respect to FIG. 17.

In some embodiments, the failover module 1160 tracks complete data transfers on the sender host or receiver host. For example, the sender-side tracking includes logging which data packets have been sent and acknowledged as received, while the receiver-side tracking includes logging which data packets have been expected and received. Discrepancies might arise if one host has not yet updated its log for a data unit or if transient network errors caused temporary misreporting of data transmission status at one host, while the other host indicates that the data unit is transmitted successfully. Data that one host logs as successfully transmitted, while the other logs as unknown or does not recognize it, will not be retransmitted.

In some embodiments, the failover module 1160 causes a combined completion log to be generated that includes complete data transfers in either the sender-side completion log or the receiver-side completion log, and drains the completed queues based on the combined completion log. Only the remaining incomplete data (that is on both the sender side and the receiver side) is retransmitted from the upstream application. This dual confirmation ensures that retransmission is based on a consensus of missing data, thus minimizing retransmission and ensuring that both sender and receiver hosts are synchronized.

In some embodiments, the failover module 1160 further monitors health metrics of the previously used NIC (that has been replaced) to determine whether the previous NIC is recovered. In response to determining that the previous NIC is recovered, the failover module 1160 migrates data transmission from one or more NICs of the at least one backup NIC back to the previous NIC. Similarly, the progress of data transmission is spoofed to the upstream application, such that the upstream application does not detect switching from the one or more NICs of the at least one backup NIC to the previous NIC. It is advantageous to continuously monitor health metrics of the previously used NIC, because the previous failure may be caused by overheating. After the overheated NIC is replaced with a backup NIC, the previous NIC will have time to cool down and recover in time.

FIG. 17 illustrates an example communication pattern 1700 between a sender host and a receiver host during a failover in accordance with one or more embodiments. Initially, both sender and receiver hosts are in a normal operational state, indicating that all functions are proceeding without any issues. At some point, either the sender host or the receiver host (or both) may detect a local queue pair failure.

Responsive to detecting a local queue pair failure at a sender NIC, the sender host stops all operations and communicates the failure to the receiver host via a “SenderFailureMsg,” and then waits for a response from the receiver host. Responsive to receiving the “SenderFailureMsg” from the sender host, the receiver host stops its operations, and selects a new path. The new path is associated with a different sender NIC. In some cases, the new path may also be associated with a different receiver NIC depending on whether the receiver host also detects a failure at its NIC. The new path is identified by a new flow label that specifies device names (e.g., newly selected NIC). The receiver host generates new queue pairs based on the new flow label, and sends the new queue pairs via a “NewQPs” message to the sender. Responsive to receiving the “NewQPs” from the receiver host, the sender host uses the new queue pairs to reset and replace its own queue pairs.

On the other side, responsive to detecting a local queue pair failure at a receiver NIC, the receiver host stops its operations, resets all active queue pairs and selects new paths. The new path is associated with a different receiver NIC. In some cases, the new path may also be associated with a different sender NIC depending on whether the sender host also detects a failure at its NIC. Similarly, the receiver host generates a new flow label that identifies the new path, and generates new queue pairs based on the new flow label. The receiver host sends the new queue pairs via a “NewQPs” message to the sender. Responsive to receiving the “NewQPs” from the receiver host, the sender host uses the new queue pairs to reset and replace its own queue pairs.

Both sender and receiver hosts reset and replace their existing queue pairs with the new queue pairs generated by the receiver host. In some embodiments, these new queue pairs are same as the queue pairs that are previously being transmitted, but associated with the new flow label. In some embodiments, an identical new label is used for both sending (forward path) and receiving (backward path) to ensure that both data and acknowledgments travel along confirmed healthy paths, as validated by the probe mesh or shadow queue pairs.

Further, the sender host sends its last completed communications at the time of failure to the receiver host via a “SenderLastCompletion” message. In response to receiving this message, the receiver verifies its own last completed communications at the time of failure with those of the sender to identify a combined set of last completed communications. The receiver host then sends this combined data to the sender host via a “CombinedLastCompletion” message. Both the receiver and the sender DO transition into the RTS state. Both sides drain their completion queues when they reset and replace queue pairs (after NewQPs) and before the SenderLastCompletion. Remaining queue pairs are connected between the sender host and the receiver host. The queue pairs at the sender host are transitioned to the ready-to-send (RTS) state, and those at the receiver host to the ready-to-receive (RTR) state. The new flow label is used to direct these queue pairs along the new path. Consequently, both hosts can engage in retransmission processes, which only transmit the remaining queue pairs, with the completed ones already drained.

Unlike traditional retransmission methods that resend data through the same NIC (temporal retransmission), the methods and system described herein enable switching to a different NIC (spatial retransmission). This approach is particularly useful when a NIC fails due to issues like overheating, as it allows the faulty NIC to cool down while maintaining network operations through an alternative NIC.

Embodiments described above are mostly related to selection of new paths involving different NICs at the sender host and/or receiver host. Similar or same principles may also be applied to selections of new paths involving the same NICs.

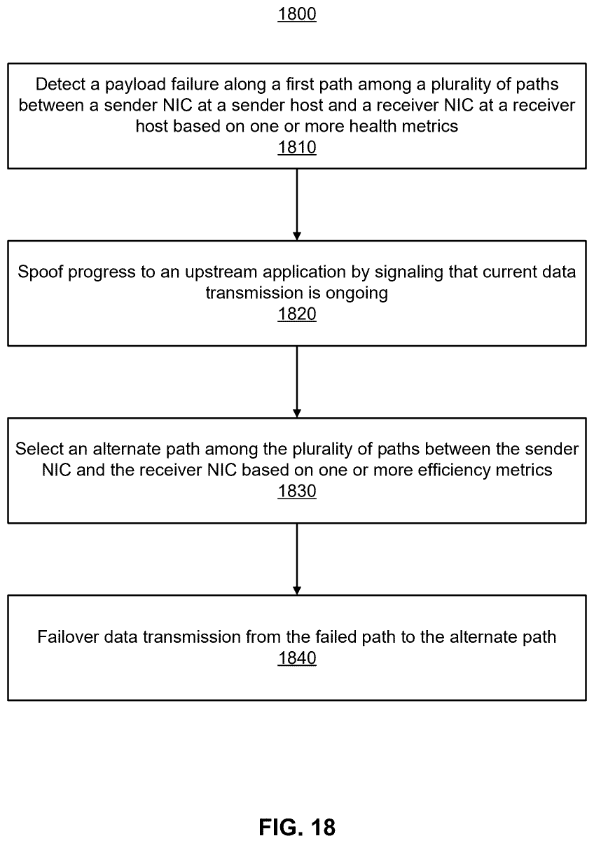

FIG. 18 is a flow chart of an example method for mitigating payload failure along a network path in accordance with one or more embodiments. The method may be performed by a system including one or more components of a sender host, receiver host, netcam module, fabric scheduler, or a combination thereof. In various embodiments, the operations depicted in FIG. 18 may be performed in a different order than illustrated, and some operations may be omitted or combined, while additional operations not shown may also be performed, depending on the system configuration or implementation requirements.

The system detects 1810 a payload failure along a first path among a plurality of paths between a sender NIC at a sender host and a receiver NIC at a receiver host based on one or more health metrics. These health metrics may include, for example, transmission timeouts, completion queue errors, abnormal one-way delays measured via NIC timestamps, or dropped packets detected using RDMA probes or shadow queue pairs. The system may also monitor ECN (Explicit Congestion Notification) marks or packet loss ratios to determine degradation in link health. Detection may be performed by the netcam module, a centralized fabric scheduler, or distributed agents at the sender or receiver hosts. A probe mesh may be deployed across the network to continuously gather data from multiple paths, and this data is analyzed to isolate failing or underperforming paths. The detection process may be proactive or reactive, triggering either in response to reaching a predefined fault threshold or via real-time alerts from local NIC monitoring components. Similar techniques are described in detail with respect to FIG. 16.

The system 1820 spoofs progress to an upstream application by signaling that current data transmission is ongoing, even when an underlying payload failure or failover operation is in progress. This spoofing mechanism ensures that the upstream application continues operating without perceiving a disruption, thereby preventing unnecessary restarts, timeouts, or failures.

For example, during a NIC failure or path failover, the failover module may generate synthetic acknowledgments, mirror successful queue completions, or intercept status messages to indicate continued delivery of packets. This prevents the upstream application from initiating a reinitialization sequence or triggering application-level error handling routines, which could otherwise cause substantial downtime. This spoofing may be implemented via kernel-level hooks, middleware logic, or network agent modules that are aware of the network state. The spoofing process allows the failover operation to proceed transparently in the background, maintaining service continuity and improving overall system resilience, particularly in large- scale distributed systems such as data center environments.

The system selects 1830 an alternate path among the plurality of paths between the sender NIC and the receiver NIC based on one or more efficiency metrics. These efficiency metrics may include the current utilization of network components (e.g., switches, NICs, or interconnects), the path's latency profile, historical packet loss, ECN mark frequency, or non-uniform memory access (NUMA) proximity between the NIC and host memory or CPU. The selection process may be executed locally by a netcam module or centrally by a fabric scheduler that collects network-wide telemetry via a probe mesh. The probe mesh helps estimate link-level utilization by observing the frequency of queuing events or congestion signals. The system may prefer paths through alternate switches, such as different spine or top-of-rack (ToR) switches (e.g., as shown in FIG. 14), to reroute around the failed path. In some implementations, the system may rank all available paths using a weighted score derived from the aforementioned metrics and select the one with the best efficiency score.

Responsive to selecting the alternate path, the system failovers 1840 data transmission from the failed path to the alternate path. This failover process may involve resetting active queue pairs (QPs) on both the sender and receiver hosts and establishing new QPs aligned with the updated routing configuration. The system coordinates the transition by sending control messages-such as SenderFailureMsg and NewQPs-between the hosts, as illustrated in FIG. 17. Queue pairs associated with the failed path are flushed, and new flow labels are assigned to ensure that both forward and reverse traffic flows traverse the newly selected healthy path. To maintain data integrity, the sender and receiver exchange completion logs to agree on the last confirmed transmission and resume from the appropriate point. If a partial data transfer was in progress, the system may initiate selective retransmissions for any unconfirmed segments. The entire process is conducted while preserving continuity at the application level, aided by spoofing mechanisms as previously described in FIG. 16.

The process described herein allows sender and receiver hosts to coordinate directly to manage failovers without relying on a centralized control system. This enhances the speed and responsiveness of the failover process, allowing for quicker recovery from failures and potentially reducing downtime.

### Failover State Machine Logic (Pseudocode Implementation)

The following pseudocode illustrates example steps executed by sender and receiver hosts during the failover process. This implementation correspond to the state transitions and message exchanges described in FIGS. 16-18.

```
  (Sender) NotifySenderFailure
# Sender detects its own NIC failure
stop_all_operations( )
send(SenderFailureMsg(faulty_queue_pairs))
wait_for_message_from_receiver( )
  (Receiver) ResetAndReplaceQPs
# Receiver reacts to failure notification
stop_all_operations( )
reset_all_active_queue_pairs( )
select_new_paths( )
create_queue_pairs_on_new_paths( )
send(NewQPs(new_active_qps, connection_info))
wait_for_message_from_sender( )
  (Sender) ResetAndReplaceQPs
# Sender receives new QP info and configures itself
stop_all_operations( )
reset_all_active_queue_pairs( )
create_queue_pairs(new_qps_from_receiver)
send(SenderLastCompletion(last_sequence_number,
connection_info))
wait_for_message_from_receiver( )
  (Receiver) Retran:PostRecv
# Receiver prepares for retransmission
CombinedLastCompletion = max(SenderLastCompletion,
ReceiverLastCompletion)
bring_active_qps_to_RTS_state( )
post_recv( )
send(CombinedLastCompletion)
return_to_normal_state( )
  (Sender) Retran:PostSend
# Sender resumes transmission
bring_active_qps_to_RTS_state( )
post_send( )
return_to_normal_state( )
```

A person skilled in the art would understand that the above pseudocode represents just one example of how sender and receiver hosts can coordinate to manage failovers in a distributed network environment. Variations in message formats, state transitions, or queue pair handling may be implemented without departing from the core principles of the invention. For example, alternative transport protocols, hardware-specific instructions, or different synchronization mechanisms may be substituted to suit particular system architectures or performance requirements. The essential concept-that sender and receiver cooperate to reset, reconfigure, and resume data transmission transparently after a failure-remains applicable across a wide range of networked computing systems.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for reconciling configuration settings for imported resources through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for mitigating payload failures in a networked computing environment, comprising:
detecting a payload failure at a sender Network Interface Card (NIC) among a plurality of sender NICs or a receiver NIC among a plurality of receiver NICs along a path between a sender host and a receiver host based on one or more health metrics;
spoofing progress to an upstream application by signaling that current data transmission is ongoing, such that the upstream application does not detect the payload failure;
selecting at least one backup NIC from the plurality of NICs of the sender host or the receiver host based on one or more efficiency metrics, wherein the one or more efficiency metrics include a proximity metric and a utilization metric of each of the plurality of NICs of the sender host; and
failing over data transmission from the sender NIC or the receiver NIC to the at least one backup NIC.

2. The method of claim 1, further comprising:
identifying combined completion log by comparing a sender-side completion log and a receiver-side completion log;
draining all completion queues based on the combined completion log; and
retransmitting incomplete queues that are not in the combined completion log from the upstream application.

3. The method of claim 1, wherein the one or more health metrics include at least a timeout in data transmission, an error in sending or receiving data, or a completion queue status.

4. The method of claim 1, the method further comprising:
monitoring health metrics of the NIC associated with the payload failure to determine whether the NIC is recovered; and
in response to determining that the NIC associated with the payload failure is recovered, migrating data transmission from one or more NICs of the at least one backup NIC back to the NIC, wherein progress of data transmission is spoofed to the upstream application, such that the upstream application does not detect switching from the one or more NICs of the at least one backup NIC to the NIC.

5. The method of claim 1, wherein the one or more health metrics are obtained from one or more of a probe mesh, shadow queue pair, application level indicators, and a centralized scheduler.

6. The method of claim 1, wherein failing over data transmission from the NIC associated with the payload failure to the at least one backup NIC includes:
transitioning all queue pairs between the sender host and the receiver host to a RESET state;
draining all completion queues between the sender host and the receiver host;
creating and connecting new queue pairs between the sender host and the receiver host; and
transitioning remaining queue pairs to ready-to-receive (RTR) and ready-to-send (RTS) state.

7. The method of claim 1, further comprising:
selecting an alternate path among the plurality of paths between the sender host and the receiver host, wherein selecting the alternate path includes:
determine health metrics of each of the plurality of network paths; and
identifying the alternate path based on the health metrics of each of the plurality of network paths;
failing over data transmission from the failed path to the selected alternative path.

8. The method of claim 7, wherein the health metrics comprise one or more of a timeout in data transmission, an error in sending or receiving data, and a completion queue status.

9. The method of claim 7, wherein failing over data transmission from the failed path to the selected alternative path comprises:
transitioning queue pairs between the sender host and the receiver host to a RESET state;
draining completion queues in the queue pairs between the sender host and the receiver host;
creating and connecting the queue pairs between the sender host and the receiver host;
generate a flow label that directs the queue pairs between the sender host and the receiver host through the selected alternative path; and
transitioning remaining queue pairs between the sender host and the receiver host through ready-to-send (RTS) state and ready-to-receive (RTR).

10. A method for mitigating payload failures in a networked computing environment, comprising:
detecting a payload failure along a path among a plurality of paths between a sender Network Interface Card (NIC) at a sender host and a receiver NIC at a receiver host based on one or more health metrics;
spoofing progress to an upstream application by signaling that current data transmission is ongoing, wherein the upstream application does not detect the payload failure;
selecting an alternate path among the plurality of paths between the sender NIC and the receiver NIC, wherein selecting the alternate path includes:
determine health metrics of each path based on at least one of probe mesh, shadow queue pair, application level indicators, or a centralized scheduler; and
identifying the alternate path based on the health metrics of each of the plurality of network paths;
failing over data transmission from the failed path to the selected alternative path.

11. The method of claim 10, wherein the one or more health metrics include at least a timeout in data transmission, an error in sending or receiving data, or a completion queue status.

12. The method of claim 11, failing over data transmission from the failed path to the selected alternative path includes:
transitioning queue pairs between the sender NIC and the receiver NIC to a RESET state;
draining completion queues in the queue pairs between the sender NIC and the receiver NIC;
creating and connecting the queue pairs between the sender NIC and the receiver NIC;
generate a flow label that directs the queue pairs between the sender NIC and the receiver NIC through the selected alternative path; and
transitioning remaining queue pairs between the sender NIC and the receiver NIC through ready-to-send (RTS) state and ready-to-receive (RTR) state.

13. The method of claim 10, wherein spoofing progress to the upstream application comprises generating synthetic acknowledgments or modifying queue completion statuses such that the upstream application continues to operate without initiating error recovery routines.

14. The method of claim 10, wherein selecting the alternate path is based on path health metrics of one or more alternate paths, the path health metrics include at least one of an one-way delay, an ECN-marked packet rate, or a bandwidth utilization.

15. The method of claim 14, wherein the alternate path is selected based on a comparison of performance scores computed for each of the plurality of network paths, each score based on a weighted combination of path health metrics.

16. The method of claim 15, further comprising: maintaining a shadow queue pair that mirrors behavior of the application queue pair to continuously track path-level health.

17. The method of claim 10, wherein failing over data transmission includes updating flow labels associated with queue pairs to route subsequent packets through the alternate path without interrupting ongoing transmissions.

18. The method of claim 10, wherein the spoofing of progress to the upstream application persists until the queue pairs associated with a new path have transitioned to a ready-to-send (RTS) and ready-to-receive (RTR) state.

19. The method of claim 10, further comprising: transmitting a failover control message from the sender NIC to the receiver NIC, the control message including identifiers for resetting and establishing new queue pairs associated with the alternate path.

20. A system for mitigating payload failures in a networked computing environment, comprising:
a sender host comprising a plurality of sender Network Interface Cards (NICs); and
a receiver host comprising a plurality of receiver NICs,
wherein the sender host is configured to execute an application that sends data packets from a sender NIC of the plurality of sender NICs to the receiver host,
wherein the receiver host is configured to receive the data packets at a receiver NIC of the plurality of receiver NICs,
wherein the sender host:
detects a payload failure at the sender NIC based on one or more health metrics;
spoof progress to the application by signaling that current data transmission is ongoing, such that the application does not detect the payload failure;
select a remaining sender NIC from the plurality of sender NICs based on one or more efficiency metrics, wherein the one or more efficiency metrics include a proximity metric and a utilization metric; and
fail over data transmission from the sender NIC to the selected remaining sender NIC.
